(19) United States
(12) Patent Application Publication
(10) Pub. No.: US 2006/0053944 A1
(43) Pub. Date: Mar. 16, 2006

(54) Cable release system, an assembly for securing a cable sheath of a cable release system to a product, and a product having an assembly for securing a cable sheath of a cable release system

(76) Inventors: Lawrence Pomerleau, Lake Zurich, IL (US); Martin J. Roden, Wauconda, IL (US); Paul J. Kudrna, Spring Grove, IL (US); Michael F. De Rossi, Lindenhurst, IL (US)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 11/225,658

(22) Filed: Sep. 13, 2005

Related U.S. Application Data
(63) Continuation-in-part of application No. 10/676,598, filed on Oct. 1, 2003.

(51) Int. Cl. F16C 1/10

(52) U.S. Cl. 74/502.4

(57) ABSTRACT

The invention provides a cable release system, an assembly for securing a cable release system to a product, and a product having an assembly for securing a cable sheath of a cable release system. The assembly defines an opening in which a cable sheath of the cable release system is secured such that the cable sheath is substantially prohibited from moving through the opening of the assembly, and such that the cable sheath is further substantially prohibited from twisting and/or kinking upon use of the cable release system. The cable release system may also be configured such that an actuation member thereof may freely rotate about an end of the cable to further prevent twisting and/or kinking of the cable upon use the cable release system.

### CROSS-REFERENCE AND INCORPORATION BY REFERENCE

This application is a Continuation-In-Part of U.S. patent application Ser. No. 10/676,598, filed on Oct. 1, 2003, and entitled “Assembly For Securing A Cable Sheath In A Cable Release System”. U.S. patent application Ser. No. 10/676,598 is hereby incorporated by reference.

### BACKGROUND OF THE INVENTION

The invention relates to a cable release system, an assembly for securing a cable sheath of a cable release system to a product, and a product having an assembly for securing a cable sheath of a cable release system. More specifically, the invention relates to a cable release system, assembly for securing a cable sheath of a cable release system to a product, and a product having an assembly for securing a cable sheath of a cable release system, wherein the product is a piece of motion furniture.

In certain pieces of motion furniture, a cable release system is utilized to allow the furniture to move from one position to another, for example, a recliner moving from an upright sitting position to a reclining position. Most cable release systems include a sheathed cable, an actuation member provided at one end of the sheathed cable, e.g., a handle, such that a user of the furniture can manipulate the cable release system to move the furniture from one position to another, a mounting bracket provided proximate to the other end of the sheathed cable, and means for moving the furniture from one position to another attached to the other end of the sheathed cable. The mounting bracket is typically provided in the interior of the furniture. One example of such a cable release system is a D-ring cable release system.

The sheath of the sheathed cable is connected to the mounting bracket, typically by sonic welding and/or gluing. The mounting bracket is then attached to the interior of the furniture by known means. Thus, the sheathed cable is fixed to the frame of the motion furniture. However, with these current methods of securing the sheath to the mounting bracket, several assembly and installation problems often occur.

One problem that has occurred is that once the mounting bracket is welded and/or glued, the mounting bracket is in a fixed position relative to the cable and sheath of the cable, and the frequent resultant twisting and kinking of the cable either caused the manufacturer of the motion furniture to remove and remount the entire cable release system, or caused the release system to malfunction in the field, resulting in inordinately expensive repair or recall.

Another problem that has occurred is that with welding and/or gluing of the mounting bracket, commonly occurring breakage or slippage due to imperfect weld and/or glue application resulted in costly repair and re-work, up to and including recall of the motion furniture.

There is also a problem with users of motion furniture having a problem with their cable fraying at the base of the actuation member as the motion of releasing the recliner mechanism in the furniture with the actuation member causes the actuation member to twist the cable. Over time, the cables will twist and kink and ultimately begin to fray.

Thus, there is a need for an improved structure of securing a cable sheath of a cable release system which overcomes the disadvantages of the prior art securing structures. The present invention provides such a structure of securing a cable sheath of a cable release system. Features and advantages of the present invention will become apparent upon a reading of the attached specification, in combination with a study of the drawings.

### SUMMARY OF THE INVENTION

Briefly, and in accordance with the foregoing, the present invention provides five embodiments of an assembly for securing a cable sheath of a cable release system.

The first embodiment of the invention provides an assembly which includes a mounting bracket, preferably of one-piece construction, which is secured to a sheath of a sheathed cable by a retaining ring rather than by sonic welding or by gluing. Securing the bracket to the sheath by the retaining ring permits free rotation of the cable sheath. The retaining ring will not slide up or down accidentally on the sheath. The retaining ring secures the bracket in place, and also permits adjustment up and down to allow for variations in user assembly requirements.

The second embodiment of the invention provides an assembly which includes a plastic bracket made as one piece with a living hinge. The upper and lower sections of the bracket are connected by a living hinge which allows the upper section to be folded over to form the bracket. The upper section has a protruding tab that snaps into a recess in the lower section, which locks the two sections together. In assembly, the wire cable with two sections of sheathing are placed between the upper and low sections so that the wire cable is located in a groove and the sheathing sections are positioned on either side of the groove. When the upper and lower sections of the bracket are closed and locked together, the two sections of sheathing are held in place by protruding spikes located in the lower section of the bracket. When the bracket is mounted to the furniture using screws, the upper and lower section of the bracket are secured together and pressure is applied to the spikes holding the sheathing sections in place. This bracket eliminates additional parts and provides assembly of the bracket and cable without the use of tools.

The third embodiment of the invention provides an assembly which includes a one piece metal bracket having a U-shaped channel and protruding tab. The cable assembly with sheathing is inserted between the U-shaped channel and the tab. The tab applies pressure and helps hold the sheathing in place. There are also dimpled protruding spikes in the top of the channel that will bite into the outer surface of the sheathing to hold it in place.

The fourth embodiment of the invention provides an assembly which includes a one piece plastic bracket having a channel through the cylinder shaped section where the metal cable is inserted. There is a center hole through which the metal cable passes and then the sheathing is threaded into each end of the channel. The interior of the channel is threaded on either side of center hole and the sheathing is threaded on the outer diameter. Separating the sheathing into two sections and threaded ends prevents the sheathing from being pulled through the bracket when pulling force is applied.

The fifth embodiment of the invention provides an assembly which includes a one piece plastic bracket having a channel through the cylinder shaped section where the metal cable is inserted. There is a center hole through which the metal cable passes and then the sheathing is threaded at one end of the channel. The interior of the channel is threaded on one side of the center hole and the sheathing is threaded on the outer diameter. The threading prevents the sheathing from being pulled through the bracket when pulling force is applied. With the fifth embodiment, an alternative cable release system is also utilized which includes a metal clasp added to the wire cable to establish travel limits of the cable when pulled, a secondary sheathing added to protect fabric on the furniture from damage and protects the cable from friction causing fraying, and an actuation member which is free to rotate to eliminate twisting of the cable.

Each of the embodiments also effectively inhibits the cable and the cable sheath from twisting and/or kinking upon use of the cable release system.

### BRIEF DESCRIPTION OF THE DRAWINGS

The features of the present invention which are believed to be novel are described in detail hereinbelow. The organization and manner of the structure and operation of the invention, together with further objects and advantages thereof, may best be understood by reference to the following description taken in connection with the accompanying drawings wherein like reference numerals identify like elements in which:

FIG. 1 is a perspective view of a prior art piece of motion furniture on which a prior art cable release system has been installed;

FIG. 2 is a side elevation view of the prior art cable release system installed in the prior art piece of motion furniture illustrated in FIG. 1;

FIG. 3 is a perspective view of a first embodiment of an assembly having a mounting bracket and a retaining ring securing a cable sheath of the cable release system;

FIG. 4 is a top elevational view of the assembly illustrated in FIG. 3 where the cable sheath is secured;

FIG. 5 is a cross-sectional view of the assembly illustrated in FIG. 4 and taken along line 5-5; and

FIG. 6 is a cross-sectional view of the assembly illustrated in FIG. 4 and taken along line 6-6.

FIG. 7 is a first perspective view of a second embodiment of an assembly used for securing a cable sheath of the cable release system;

FIG. 8 is a second perspective view of the assembly illustrated in FIG. 7;

FIG. 9 is the perspective view of the assembly illustrated in FIG. 7, illustrating the connection of the cable sheath and flexible cable of the cable release system to the assembly;

FIG. 10 is a perspective view of the assembly illustrated in FIG. 7 illustrating the cable release system being secured within the assembly;

FIG. 11 is a first perspective view of a third embodiment of an assembly used for securing a cable sheath of the cable release system;

FIG. 12 is a second perspective view of the assembly illustrated in FIG. 11;

FIG. 13 is a bottom view of the assembly illustrated in FIG. 11;

FIG. 14 is a side view of the assembly illustrated in FIG. 11;

FIG. 15 is the perspective view of the assembly illustrated in FIG. 1, illustrating the cable release system being secured within the assembly;

FIG. 16 is the perspective view of the assembly illustrated in FIG. 12, illustrating the cable release system being secured within the assembly;

FIG. 17 is a perspective view of a fourth embodiment of an assembly used for securing a cable sheath of the cable release system;

FIG. 18 is a second perspective view of the assembly illustrated in FIG. 17;

FIG. 19 is a side elevational view of the assembly illustrated in FIG. 17;

FIG. 20 is a cross-sectional view taken along line 20-20 of FIG. 19;

FIG. 21 is a side elevational view of the cable sheath of the cable release system;

FIG. 22 is the perspective view of the assembly illustrated in FIG. 17, illustrating the cable release system being secured within the assembly;

FIG. 23 is a perspective view of a fifth embodiment of an assembly used for securing a cable sheath of the cable release system;

FIG. 24 is a second perspective view of the assembly illustrated in FIG. 23;

FIG. 25 is a top plan view of the assembly illustrated in FIG. 23;

FIG. 26 is a cross-sectional view taken along line 26-26 of FIG. 25;

FIG. 27 is a side elevational view of an alternative cable release system used in connection with the assembly illustrated in FIG. 23;

FIG. 28 is a perspective view of a D-ring actuation member configured to be secured to the alternative cable release system illustrated in FIG. 27;

FIG. 29 is a top plan view of the D-ring actuation member illustrated in FIG. 28;

FIG. 30 is a bottom plan view of the D-ring actuation member illustrated in FIG. 28;

FIG. 31 is a cross-sectional view taken along line 31-31 of FIG. 30;

FIG. 32 is a top plan view illustrating the alternative cable release system illustrated in FIG. 27, including the D-ring actuation member illustrated in FIG. 28, being secured to the assembly illustrated in FIG. 23;

FIG. 33 is a perspective view of an alternative D-ring actuation member configured to be secured to the alternative cable release system illustrated in FIG. 27;

FIG. 34 is a second perspective view of the alternative D-ring actuation member illustrated in FIG. 33;

FIG. 35 is a top plan view of the alternative D-ring actuation member illustrated in FIG. 33;

FIG. 36 is a bottom plan view of the alternative D-ring actuation member illustrated in FIG. 33; and

FIG. 37 is a top plan view illustrating the alternative cable release system illustrated in FIG. 27, including the alternative D-ring actuation member illustrated in FIG. 33, being secured to the assembly illustrated in FIG. 23.

### DETAILED DESCRIPTION OF THE ILLUSTRATED EMBODIMENTS

While this invention may be susceptible to embodiment in different forms, there is shown in the drawings and will be described herein in detail, specific embodiments with the understanding that the present disclosure is to be considered an exemplification of the principles of the invention, and is not intended to limit the invention to that as illustrated and described herein.

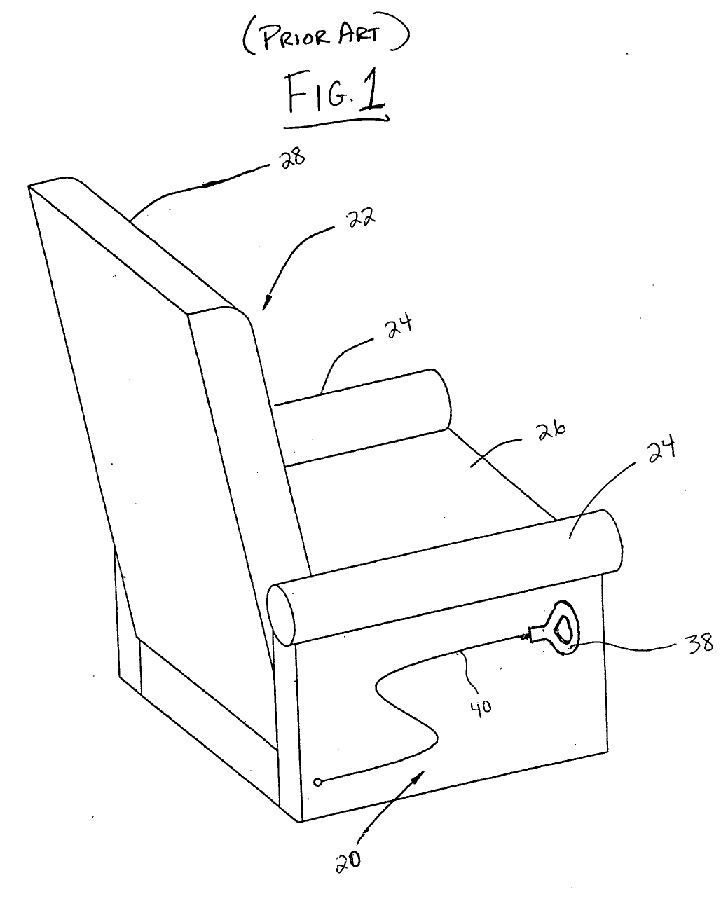

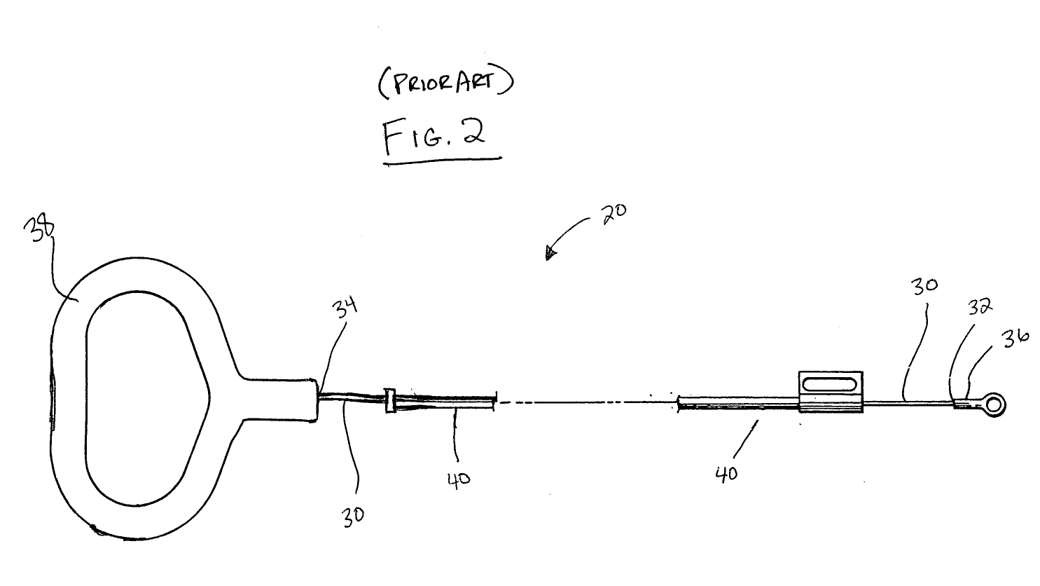

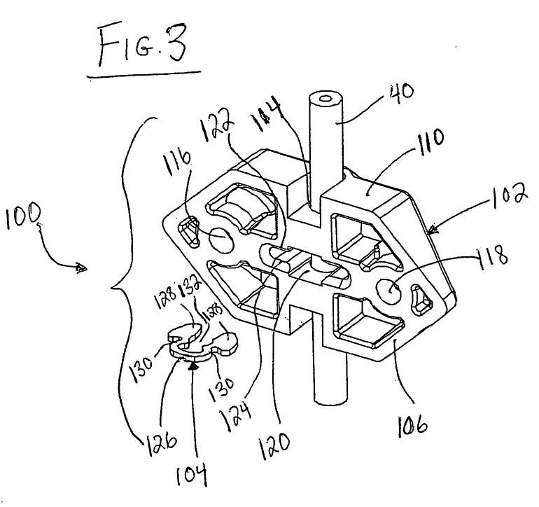

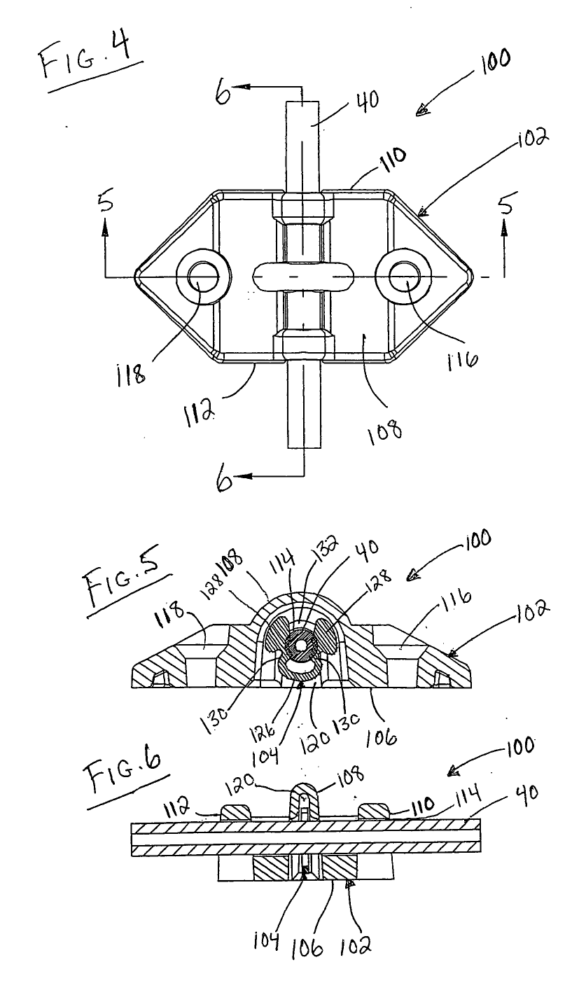

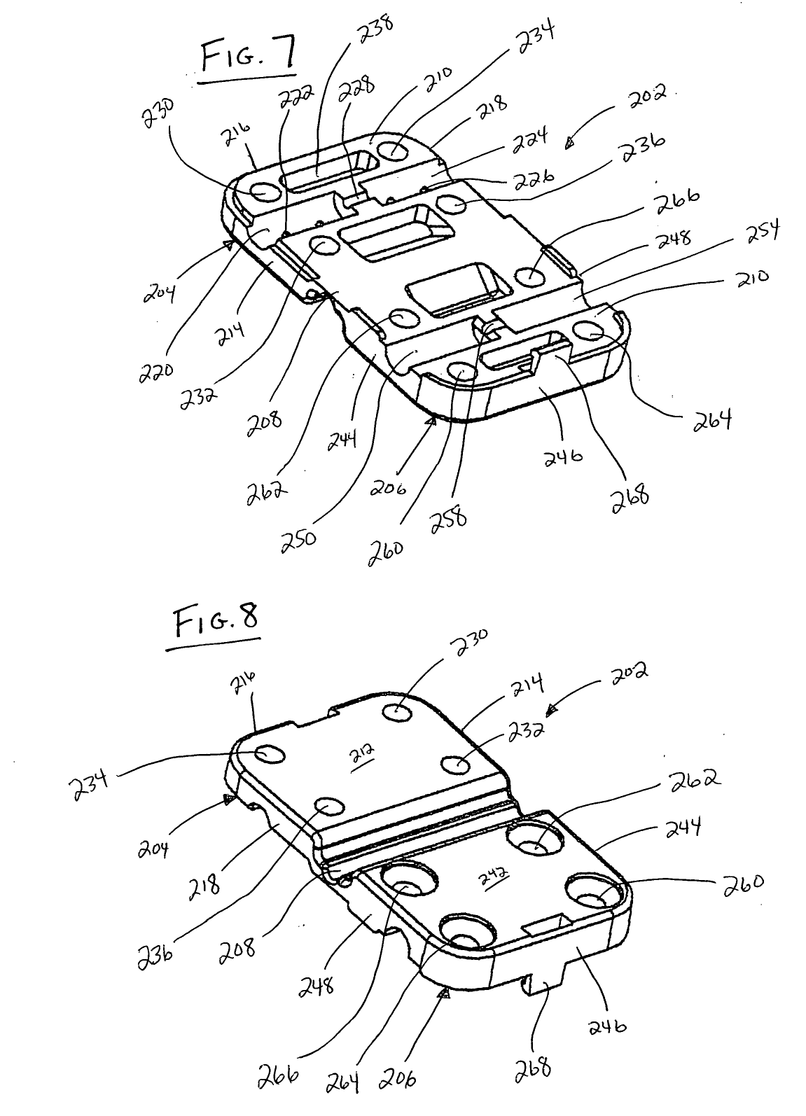

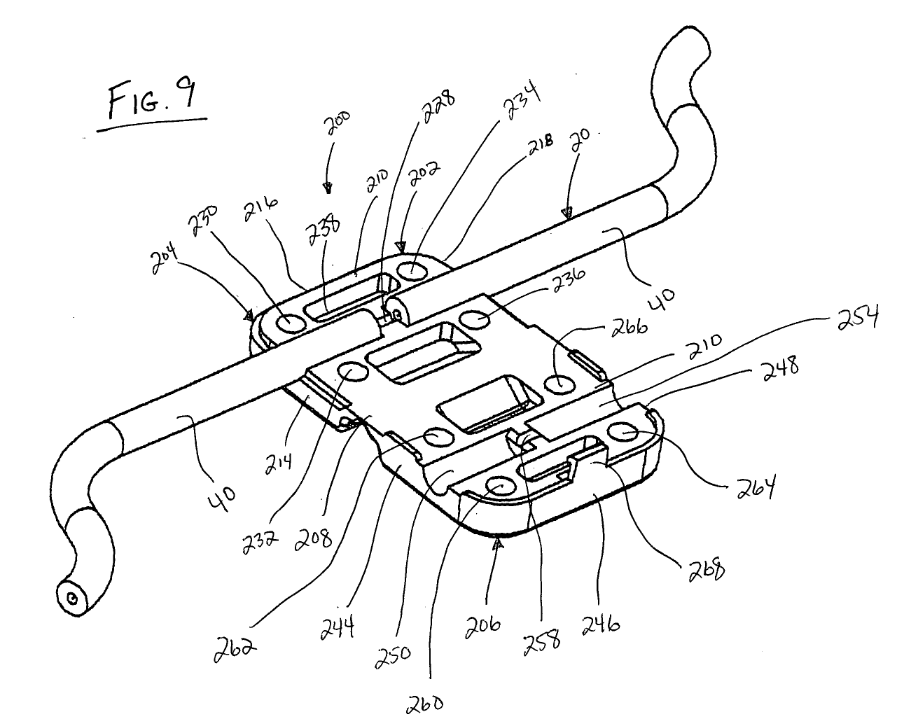

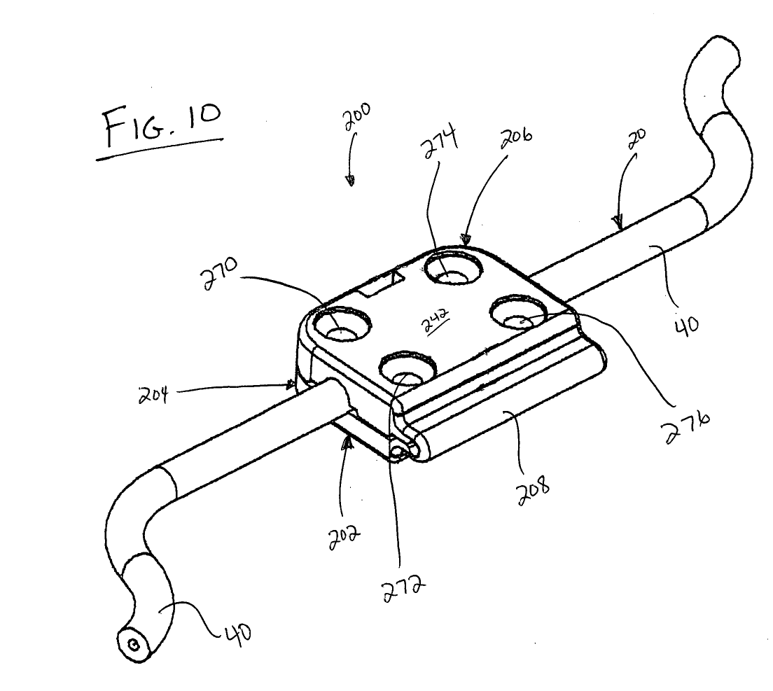

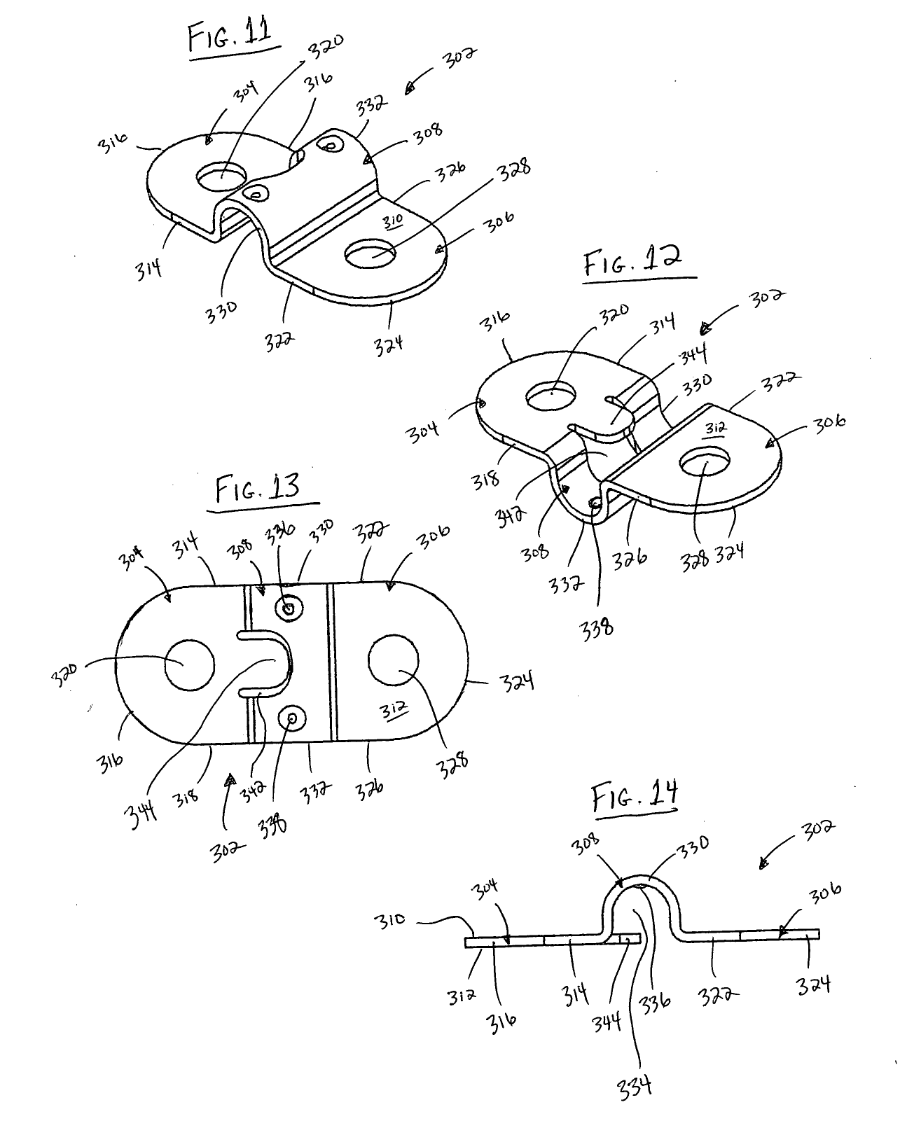

As shown in FIG. 1, a prior art cable release system 20 is installed on a prior art piece of motion furniture 22, such as a recliner chair. The recliner chair 22 includes arms 24, a seat 26, a back 28, and an extendible leg rest (not shown). A suitable mechanism (not shown) is provided to support the seat 26, the back 28 and the leg rest from the foundation of the recliner chair 22 and under control of the individual sitting in the recliner chair 22 to allow desired movement of the seat 26, back 28 and leg rest in any desired manner as is fully understood in the motion furniture industry. The cable release system 20 as hereinafter described is intended to provide the individual with the option of sitting in the recliner chair 22 with the components thereof fixed in the folded position or actuation of the cable release system 20 to allow the components to unfold into a reclining position.

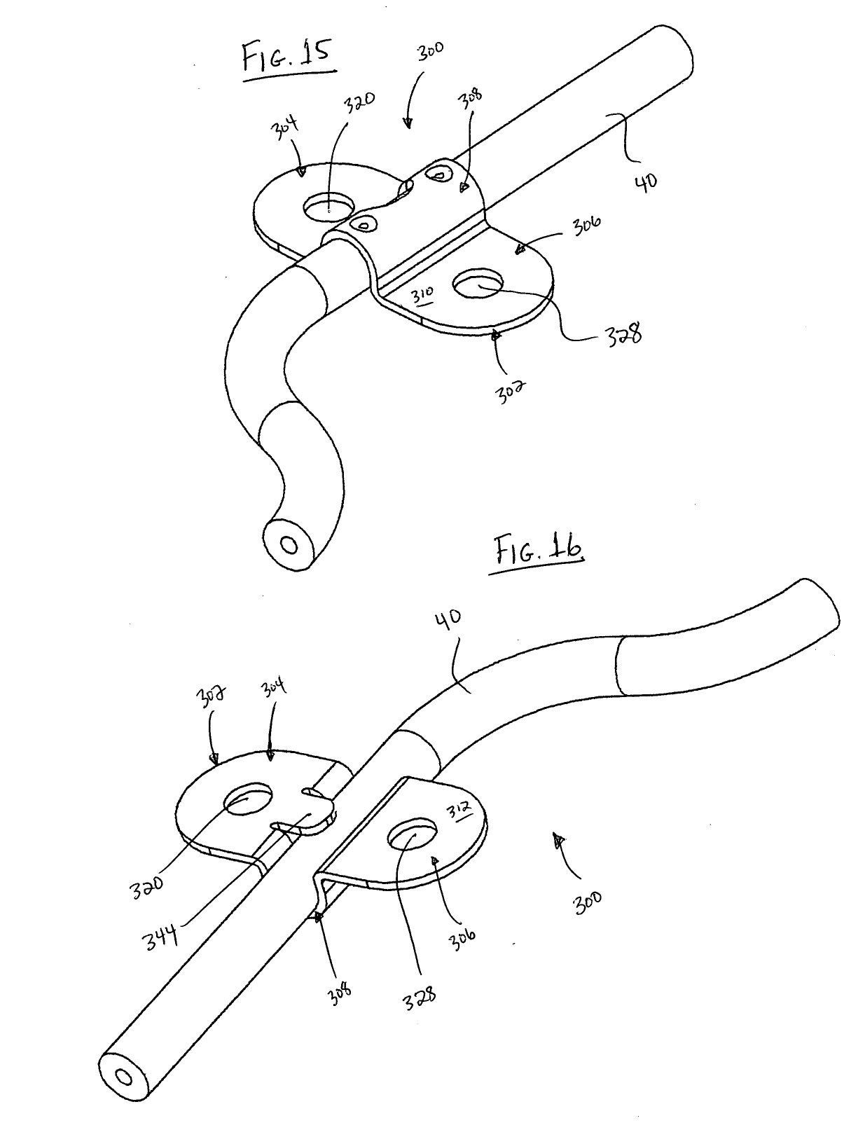

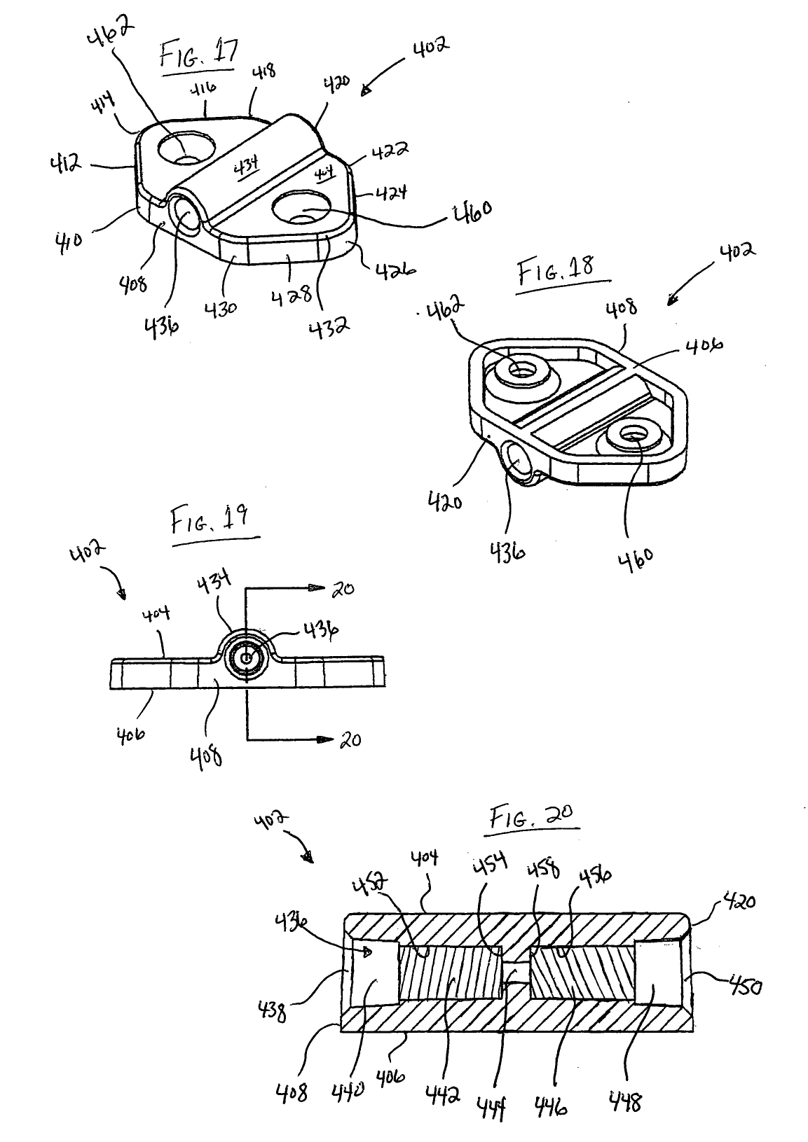

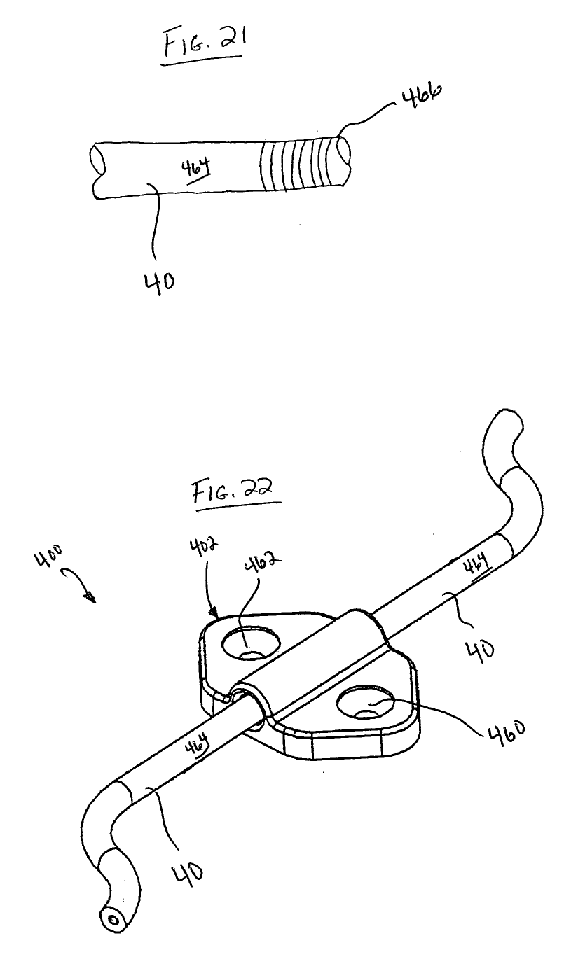

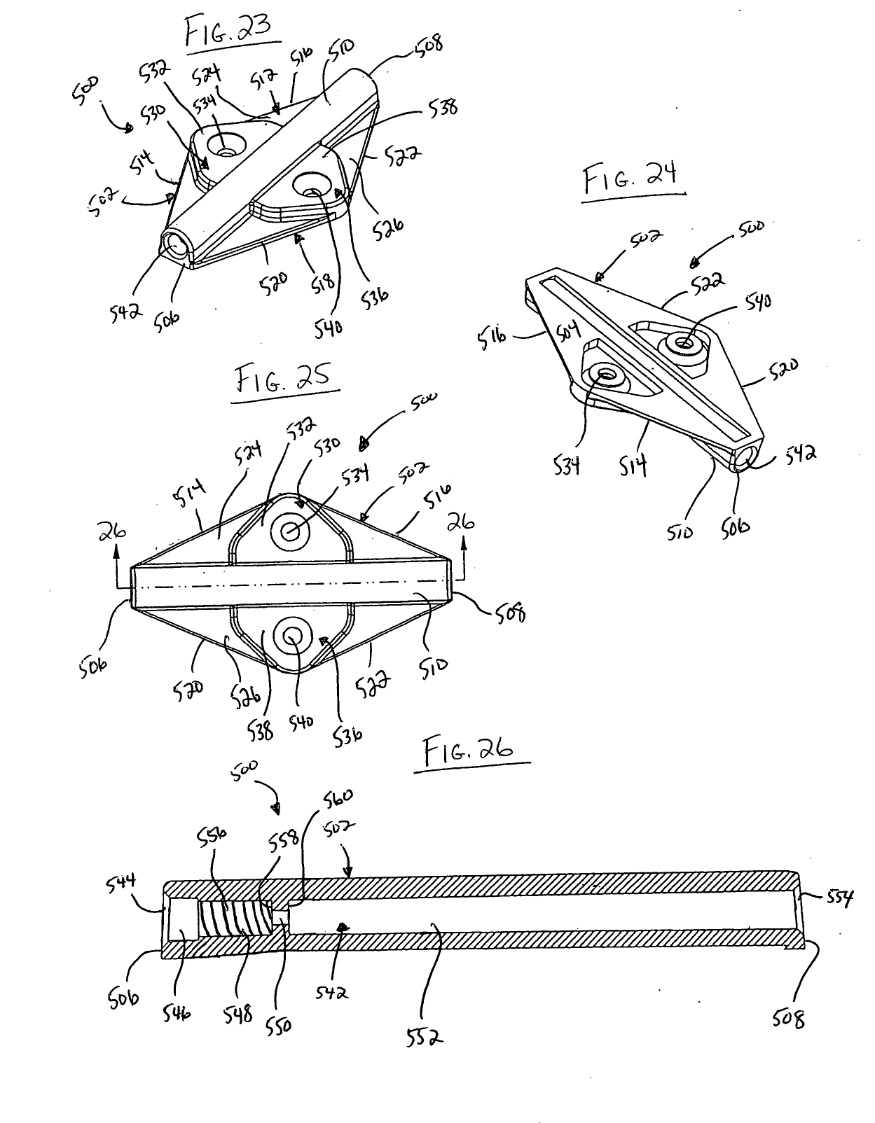

As illustrated in FIG. 2, the cable release system 20 includes a flexible cable 30 having a first end 32 and a second end 34. The first end 32 of the flexible cable 30 is secured to a connector member 36. The second end 34 of the flexible cable 30 is secured to an actuation member 38, illustrated in FIG. 2 as a D-ring. A sheath 40 encapsulates a substantial portion of the flexible cable 30 between the first and second ends 32, 34, but allows for movement of the flexible cable 30 through the sheath 40. It is to be understood that other types of connector members 36 or actuation members 38 could be utilized with the cable release system 20 than those illustrated, as such connector members 36 and actuation members 38 are well known in the art.

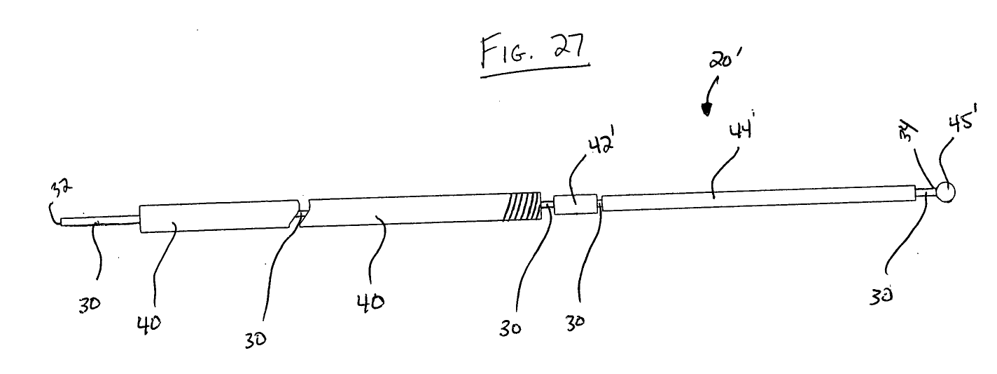

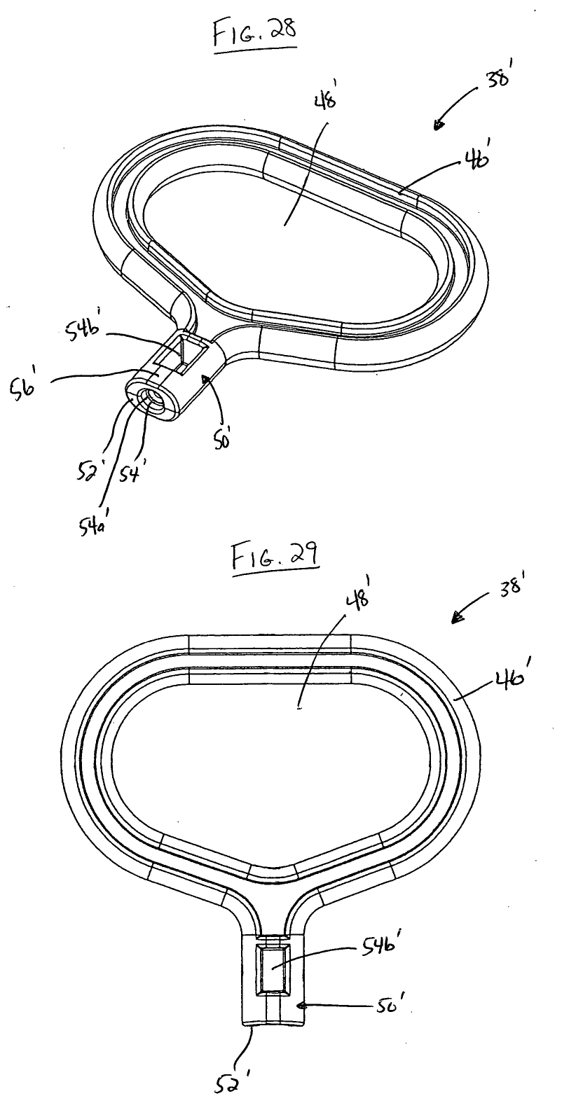

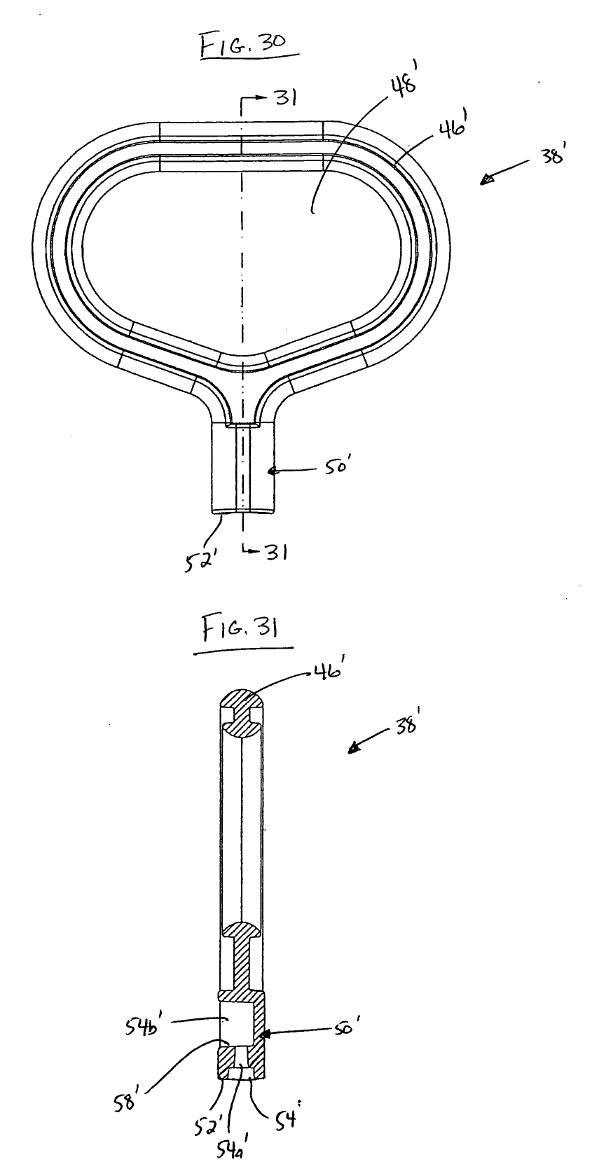

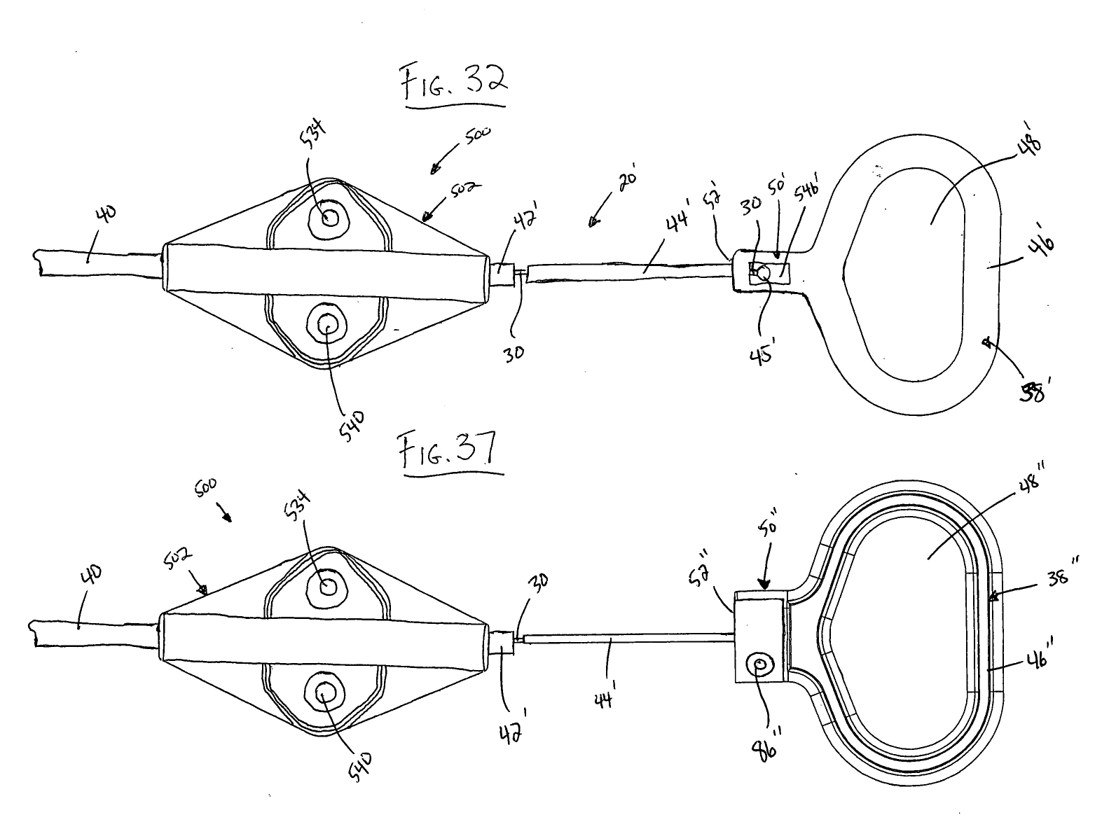

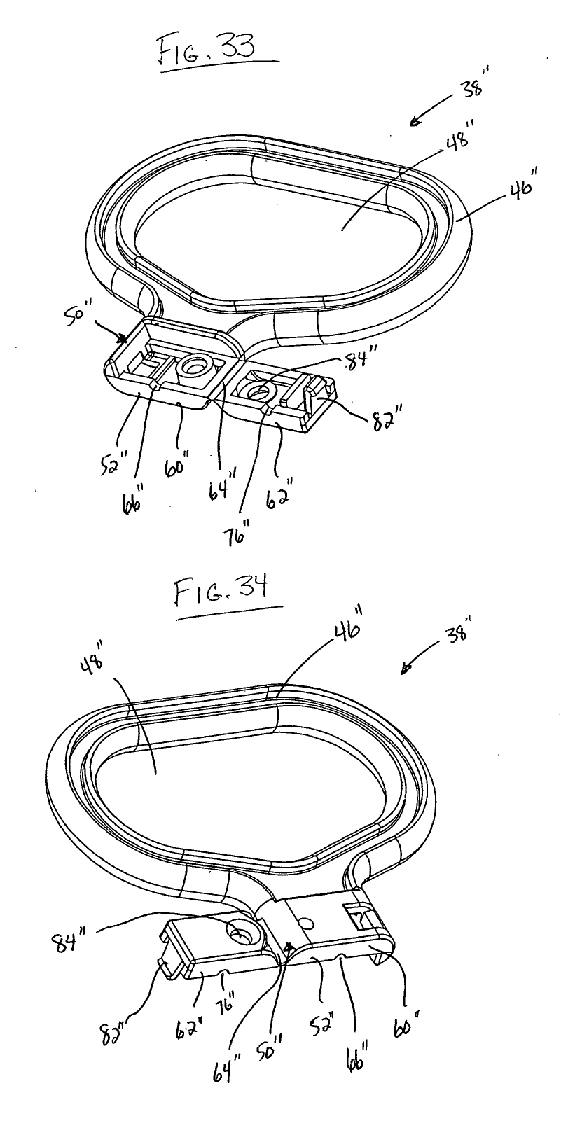

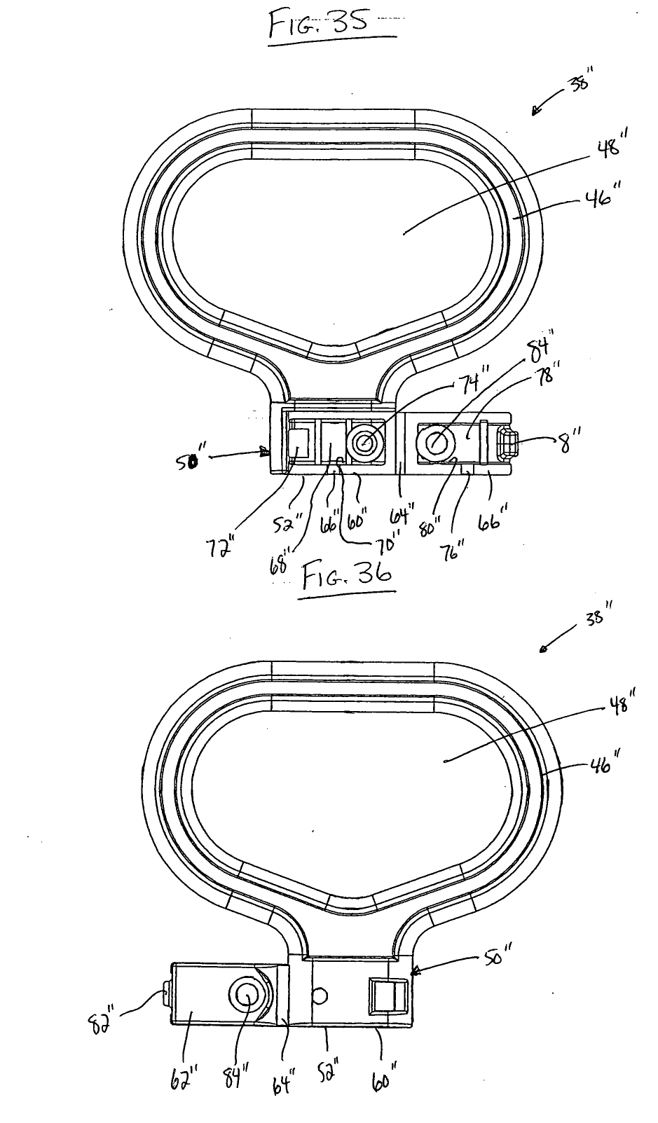

Attention is now directed to the various embodiments of the invention. A first embodiment of an assembly 100 is shown in FIGS. 3-6 and elements are denoted with reference numerals in the one hundreds. A second embodiment of an assembly 200 is shown in FIGS. 7-10 and elements are denoted with reference numerals in the two hundreds. A third embodiment of an assembly 300 is shown in FIGS. 11-16 and elements are denoted with reference numerals in the three hundreds. A fourth embodiment of an assembly 400 is shown in FIGS. 17-22 and elements are denoted with reference numerals in the four hundreds. A fifth embodiment of an assembly 500 is shown in FIGS. 23-37. The assemblies 100, 200, 300, 400, 500 of the invention are used for securing the sheath 40 of the cable release system 20 to the motion furniture 22. It should be noted that the cable release system 20 could be utilized in connection with products other than motion furniture 22 where appropriate, such that the assemblies 100, 200, 300, 400, 500 could also be utilized to secure the sheath 40 of the cable release system 20 to these other products.

Directing attention to the first embodiment of the invention, which is illustrated in FIGS. 3-6, the assembly 100 is used for securing the sheath 40 of the cable release system 20 to the motion furniture 22. The assembly 100 includes a mounting bracket 102 and a retaining ring 104.

The mounting bracket 102 is preferably formed of a one-piece construction and is configured to have a first side surface 106, a second side surface 108, a top surface 110 which connects the first side surface 106 to the second side surface 108, and a bottom surface 112 which connects the first side surface 106 to the second side surface 108.

The first side surface 106 is planar and is preferably configured such that it is positioned against an interior, mounting surface (not shown) of the motion furniture 22. The second side surface 108 can be configured such that it is either planar or non-planar, but it is preferably configured such that it does not interfere with any part of the motion furniture 22 in which the cable release system 20 is provided.

The mounting bracket 102 has an aperture 114 which extends through the mounting bracket 102 from the top surface 110 to the bottom surface 112. The aperture 114 must be large enough such that the cable sheath 40 can be positioned therethrough, but must not be large enough such that the cable sheath 40 is allowed to freely move in a lateral position within the aperture 114 of the mounting bracket 102. The aperture 114 is preferably provided in a middle portion of the mounting bracket 102.

The mounting bracket 102 preferably has two apertures 116, 118 which extend through the mounting bracket 102 from the first side surface 106 to the second side surface 108. The aperture 116 is preferably provided on one side of the aperture 114 of the mounting bracket 102, while the aperture 118 is preferably provided on an opposite side of the aperture 114 of the mounting bracket 102. The apertures 116, 118 are provided in the mounting bracket 102 such that the mounting bracket 102 can be secured to the motion furniture 22. The first side surface 106 of the mounting bracket 102 is positioned against the interior mounting surface of the motion furniture 22 and fasteners (not shown) are inserted into the apertures 116, 118 from the second side surface 108 of the mounting bracket 102 and secured to the motion furniture 22. The mounting bracket 102 could also be secured to the motion furniture 22 by other known means.

The mounting bracket 102 includes a cavity 120 which extends into the mounting bracket 102 from the first side surface 106, but preferably does not extend through the mounting bracket 102 to the second side surface 104. The cavity 120 extends into the mounting bracket 102 and is in communication with the aperture 114 of the mounting bracket 102. The cavity 120 is wider than the aperture 114 such that an upper shoulder 122 is provided by the cavity 120 and such that a lower shoulder 124 is provided by the cavity 120. The purpose for the cavity 120 and the upper and lower shoulders 122, 124 will be discussed further herein.

The mounting bracket 102 may also have further cavities and apertures provided therein or therethrough in order to minimize the amount of material used to form the mounting bracket 102, thus reducing the cost of manufacture of the mounting bracket 102.

The retaining ring 104 is preferably an open-ended spring steel ring which includes a middle section 126, a pair of enlarged end sections 128, and a pair of intermediate sections 130 which interconnect the end sections 128 with the middle section 126. The enlarged end sections 128 are spaced apart from one another to define an opening 132 located opposite the middle section 126. When the retaining ring 104 is in its normal position, the opening 132 is smaller between the enlarged end sections 128 than between the intermediate sections 130. The retaining ring 104 can also be formed in the manner illustrated and described in U.S. Pat. No. 4,886,408.

In operation, the cable sheath 40 is inserted through the aperture 114 of the mounting bracket 102 such that the cable sheath 40 is accessible through the cavity 120 from the first side surface 106 of the mounting bracket 102. The retaining ring 104 is then inserted into the cavity 120 from the first side surface 106 of the mounting bracket 102 such that the enlarged end sections 128 of the retaining ring 104 face the second side surface 108 of the mounting bracket 102. The enlarged end sections 128 are moved against the cable sheath 40 within the cavity 120 between the upper shoulder 122 and the lower shoulder 124. The enlarged end sections 128 are thus moved away from one another and the cable sheath 40 is moved into the opening 132 of the retaining ring 104. The enlarged end sections 128 are then secured to the cable sheath 40.

The retaining ring 104 is thus secured to the cable sheath 40 within the cavity 120 of the mounting bracket 102 between the upper shoulder 122 and the lower shoulder 122, thus completing the assembly 100. The retaining ring 104 permits free rotation of the cable sheath 40. The retaining ring 104 will not slide up or down accidentally on the cable sheath 40 as the retaining ring 104 is prevented from moving too far up or down on the cable sheath 40 because of the confines of the cavity 120 defined by the upper shoulder 122 and the lower shoulder 124. Thus, the retaining ring 104 of the assembly 100 secures the cable sheath 40 in place relative to the mounting bracket 102, but permits adjustment up and down to allow for variations in user assembly requirements of the motion furniture 22.

The retaining ring 104 is adjustable and removable. The retaining ring 104 secures the mounting bracket 102 in place vertically, permitting desirable free rotation of the mounting bracket 102 horizontally to prevent kinking or twisting of the cable sheath 40. The securement of the mounting bracket 102 to the cable sheath 40 by the retaining ring 104 eliminates the frequently occurring and costly problems caused by slippage of the bracket resulting from broken or inadequate weld/glue applications. The easy removability of the retaining ring 104 enables the mounting bracket 102 to be readjusted before or after assembly, allowing for variations in a manufacturer's final assembly requirements. The retaining ring 104 permits the end user to install the assembly 100 at any vertical point on the cable sheath 40 in order to provide greater flexibility than was heretofore available, permitting greater flexibility for the furniture retailer with minimal stock-keeping units needed.

Directing attention to the second embodiment of the invention, which is illustrated in FIGS. 7-10, the assembly 200 is used for securing the sheath 40 of the cable release system 20 to the motion furniture 22. The assembly 200 includes a mounting bracket 202.

As best illustrated in FIGS. 7 and 8, the mounting bracket 202 is preferably formed of a one-piece construction and is configured to have a lower portion 204 and an upper portion 206 which are connected to one another by a living hinge 208. The living hinge 208 is a thin section of material that connects the lower portion 204 and the upper portion 206 in order to keep them together and to allow the upper portion 206 to be folded over onto the lower portion 204, or unfolded off of the lower portion 204, as desired.

The lower portion 204 is configured to have an upper surface 210, a lower surface 212, a first side surface 214 which connects the upper and lower surfaces 210, 212 together, a second side surface 216 which connects the upper and lower surfaces 210, 212 together, and a third side surface 218 which connects the upper and lower surfaces 210, 212 together. The first and third side surfaces 214, 218 are generally positioned opposite and parallel to one another, with the second side surface 216 connecting the first and third side surfaces 214, 218 and being generally perpendicular to the first and third side surfaces 214, 218. The living hinge 208 is positioned generally opposite the second side surface 216.

A first semicircular elongated groove 220, which appears to be an inverted arch, is provided in the upper surface 210 of the lower portion 204 and extends from the first side surface 214, such that the first semicircular elongated groove 220 is accessible through the first side surface 214, toward the third side surface 218, but does not extend to the third side surface 218. The first semicircular elongated groove 220 is generally parallel to the second side surface 216 and the living hinge 208. A radius of the first semicircular elongated groove 220 is dependent on a radius of the cable sheath 40 for reasons which will be discussed further herein. At least one spike member 222, and preferably a plurality of spike members 222, protrudes from the first semicircular elongated groove 220 toward the upper surface 210.

A second semicircular elongated groove 224, which appears to be an inverted arch, is provided in the upper surface 210 of the lower portion 204 and extends from the third side surface 218, such that the second semicircular elongated groove 224 is accessible through the third side surface 218, toward the first side surface 214, but does not extend to the first side surface 214. The second semicircular elongated groove 224 is generally parallel to the second side surface 216 and the living hinge 208. A radius of the second semicircular elongated groove 224 is dependent on a radius of the cable sheath 40 for reasons which will be discussed further herein. At least one spike member 226, and preferably a plurality of spike members 226, protrudes from the second semicircular elongated groove 224 toward the upper surface 210.

A third semicircular elongated groove 228, which appears to be an inverted arch, is provided in the upper surface 210 of the lower portion 204 and extends between the first semicircular elongated groove 220 and the second semicircular elongated groove 224, such that the first and second semicircular elongated grooves 220, 224 are in communication with one another through the third semicircular elongated groove 228. The third semicircular elongated groove 228 is generally parallel to the second side surface 216 and the living hinge 208, such that the first, second and third semicircular elongated grooves 220, 224, 228 are generally provided for in a straight line. It should be noted that the first, second and third semicircular elongated grooves 220, 224, 228 could be provided for in configurations other than a straight line if desired. A radius of the third semicircular elongated groove 228 is dependent on a radius of the flexible cable 30 for reasons which will be discussed further herein, such that the third semicircular elongated groove 228 is not as deep relative to the upper surface 210 as are the first and second third semicircular elongate grooves 220, 224.

First, second, third and fourth apertures 230, 232, 234, 236 are provided through the lower portion 204 from the upper surface 210 to the lower surface 212. The first aperture 230 is positioned proximate to the connection of the first and second side surfaces 214, 216. The second aperture 232 is positioned proximate to the connection of first side surface 214 and the living hinge 208, on the opposite side of the first semicircular elongated groove 220 than the first aperture 230. The third aperture 234 is positioned proximate to the connection of the first and third side surfaces 214, 218. The fourth aperture 236 is positioned proximate to the connection of the third side surface 218 and the living hinge 208, on the opposite side of the second semicircular elongated groove 224 than the third aperture 234.

A recess 238 is provided in the upper surface 210 of the lower portion 204. The recess 238 is positioned between the first and third apertures 230, 234 and between the second side surface 216 and the third semicircular elongated groove 228.

The upper portion 206 is configured to have an upper surface 240, which is substantially co-planar with the upper surface 210 of the lower portion 204 as illustrated in FIG. 7, a lower surface 242, which is substantially co-planar with the lower surface 212 of the lower portion 204 as illustrated in FIG. 8, a first side surface 244 which connects the upper and lower surfaces 240, 242 together, which is substantially co-planar with the first side surface 214 of the lower portion 204, a second side surface 246 which connects the upper and lower surfaces 240, 242 together, which is substantially parallel with the second side surface 216 of the lower portion 204, and a third side surface 248 which connects the upper and lower surfaces 240, 242 together, which is substantially co-planar with the third side surface 218 of the lower portion 204. The first and third side surfaces 244, 248 are generally positioned opposite and parallel to one another, with the second side surface 246 connecting the first and third side surfaces 244, 248 and being generally perpendicular to the first and third side surfaces 244, 248. The living hinge 208 is positioned generally opposite the second side surface 246.

A first semicircular elongated groove 250, which appears to be an inverted arch, is provided in the upper surface 240 of the upper portion 206 and extends from the first side surface 244, such that the first semicircular elongated groove 250 is accessible through the first side surface 244, toward the third side surface 248, but does not extend to the third side surface 248. The first semicircular elongated groove 250 is generally parallel to the second side surface 246 and the living hinge 208. A radius of the first semicircular elongated groove 250 is dependent on a radius of the cable sheath 40 for reasons which will be discussed further herein, and is preferably of the same radius as the first semicircular elongated groove 220 provided in the lower portion 204.

A second semicircular elongated groove 254, which appears to be an inverted arch, is provided in the upper surface 240 of the upper portion 206 and extends from the third side surface 248, such that the second semicircular elongated groove 254 is accessible through the third side surface 248, toward the first side surface 244, but does not extend to the first side surface 244. The second semicircular elongated groove 254 is generally parallel to the second side surface 246 and the living hinge 208. A radius of the second semicircular elongated groove 254 is dependent on a radius of the cable sheath 40 for reasons which will be discussed further herein, and is preferably of the same radius as the second semicircular elongated groove 224 provided in the lower portion 204.

A third semicircular elongated groove 258, which appears to be an inverted arch, is provided in the upper surface 240 of the upper portion 206 and extends between the first semicircular elongated groove 250 and the second semicircular elongated groove 254, such that the first and second semicircular elongated grooves 250, 254 are in communication with one another through the third semicircular elongated groove 258. The third semicircular elongated groove 258 is generally parallel to the second side surface 246 and the living hinge 208, such that the first, second and third semicircular elongated grooves 250, 254, 258 are generally provided for in a straight line. It should be noted that the first, second and third semicircular elongated grooves 250, 254, 258 could be provided for in configurations other than a straight line if desired, so long as they mirror the configurations of the first, second and third semicircular elongated grooves 220, 224, 228 of the lower portion 204. A radius of the third semicircular elongated groove 258 is dependent on a radius of the flexible cable 30 for reasons which will be discussed further herein, such that the third semicircular elongated groove 258 is not as deep relative to the upper surface 210 as are the first and second semicircular elongate grooves 250, 254, and is preferably of the same radius as the third semicircular elongated groove 228 provided in the lower portion 204.

First, second, third and fourth apertures 260, 262, 264, 266 are provided through the upper portion 206 from the upper surface 240 to the lower surface 242. The first aperture 260 is positioned proximate to the connection of the first and second side surfaces 244, 246. The second aperture 262 is positioned proximate to the connection of first side surface 244 and the living hinge 208, on the opposite side of the first semicircular elongated groove 250 than the first aperture 260. The third aperture 264 is positioned proximate to the connection of the first and third side surfaces 244, 248. The fourth aperture 266 is positioned proximate to the connection of the third side surface 248 and the living hinge 208, on the opposite side of the second semicircular elongated groove 254 than the third aperture 264.

A tab member 268 extends outwardly from the upper surface 240 of the upper portion 206. The tab member 268 is positioned between the first and third apertures 260, 264 and between the second side surface 246 and the third semicircular elongated groove 258.

In operation, and as illustrated in FIG. 9, the cable sheath 40 is split into two separate pieces such that a first part of the cable sheath 40 can be positioned within the first semicircular elongated groove 220 of the lower part 204 of the mounting bracket 202, and such that a second part of the cable sheath 40 can be positioned within the second semicircular elongated groove 224 of the lower part 204 of the mounting bracket 202. With the cable sheath 40 split into two pieces, the flexible cable 30 is exposed between the two pieces such that the exposed flexible cable 30 can be positioned within the third semicircular elongated groove 228 of the lower part 204 of the mounting bracket 202.

As illustrated in FIG. 10, the upper portion 206 of the mounting bracket 202 is folded over the lower portion 204 of the mounting bracket 202 along the living hinge 208. The folding over of the upper portion 206 causes the following to occur: (1) the upper surface 240 of the upper portion 206 to face the upper surface 210 of the lower portion 204; (2) the first aperture 260 of the upper portion 206 is placed into communication with the first aperture 230 of the lower portion 204, in order to form a first-through aperture 270; (3) the second aperture 262 of the upper portion 206 is placed into communication with the second aperture 232 of the lower portion 204, in order to form a second-through aperture 272; (4) the third aperture 264 of the upper portion 206 is placed into communication with the third aperture 234 of the lower portion 204, in order to form a third-through aperture 274; (5) the fourth aperture 266 of the upper portion 206 is placed into communication with the fourth aperture 236 of the lower portion 204, in order to form a fourth-through aperture 276; (6) the first semicircular elongated groove 250 of the upper portion 206 is positioned around the first part of the cable sheath 40 such that the first semicircular elongated grooves 220, 250 of the lower and upper portions 204, 206 generally encapsulate the first part of the cable sheath 40, with the first semicircular elongated grooves 220, 250 generally forming a first circular elongated groove 278; (7) the second semicircular elongated groove 254 of the upper portion 206 is positioned around the second part of the cable sheath 40 such that the second semicircular elongated grooves 224, 254 of the lower and upper portions 204, 206 generally encapsulate the second part of the cable sheath 40, with the second semicircular elongated grooves 224, 254 generally forming a second circular elongated groove (not shown); (8) the third semicircular elongated groove 258 of the upper portion 206 is positioned around the exposed flexible cable 30 such that the third semicircular elongated grooves 228, 258 of the lower and upper portions 204, 206 generally encapsulate the exposed flexible cable 30, with the third semicircular elongated grooves 228, 258 generally forming a third circular elongated groove (not shown); and (9) the tab member 268 of the upper portion 206 is received and locked in the recess 238 of the lower portion 204, thus securing the lower and upper portions 204, 206 together in a closed position.

When the mounting bracket 202 is in the closed positioned, as illustrated in FIG. 10, the first and second parts of the cable sheath 40 are held in place/secured by the protruding spike members 222, 226 provided in the lower portion 204 of the mounting bracket 202, such that the first part of the cable sheath 40 is not able to exit the first circular elongated groove 278, and such that the second part of the cable sheath 40 is not able to exit the second circular elongated groove (not shown).

Fastening members (not shown), such as screws, can then be inserted through one or more of the first, second, third and fourth-through apertures 270, 272, 274, 276 to mount/secure the mounting bracket 202 to the motion furniture 22. The fastening members further secure the lower and upper portions 204, 206 of the mounting bracket 202 together, and further applies pressure to the spike members 222, 226 holding the first and second parts of the cable sheath 40 in place.

The assembly 200 thus eliminates additional parts and provides for assembly of the mounting bracket 202 to the cable release system 20 without the use of tools. The securement of the cable sheaths 40 to the mounting bracket 202 also assists in inhibiting the cable sheaths 40 and the cable 30 from twisting and/or kinking during use.

Directing attention to the third embodiment of the invention, which is illustrated in FIGS. 11-16, the assembly 300 is used for securing the sheath 40 of the cable release system 20 to the motion furniture 22. The assembly 300 includes a mounting bracket 302.

As best illustrated in FIGS. 11-14, the mounting bracket 302 is preferably formed of a one-piece construction and is configured to have first, second and third portions 304, 306, 308 and upper and lower surfaces 310, 312.

The upper and lower surfaces 310, 312 of the first portion 304 are generally straight and parallel to one another and are separated from one another by first, second, third and fourth side edges 314, 316, 318 (the fourth side edge is not shown). First and third side edges 314, 318 are positioned opposite from one another and are generally parallel to one another. The second side edge 316 connects a first side of the first side edge 314 to a first side of the third side edge 318. The second side edge 316 is generally outwardly curved such that the first, second and third side edges 314, 316, 318 generally are formed in a U-shaped configuration. The fourth side edge (not shown) connects a second side of the first side edge 314 to a second side of the third side edge 318. The fourth side edge is generally perpendicular to the first and third side edges 314, 318 and positioned opposite of the second side edge 316. An aperture 320 is provided generally through a center of the first portion 304 from the upper surface 310 to the lower surface 312.

The second portion 306 is generally identical to the first portion 304. The upper and lower surfaces 310, 312 of the second portion 306 are generally straight and parallel to one another and are separated from one another by first, second, third and fourth side edges 322, 324, 326 (the fourth side edge is not shown). First and third side edges 322, 326 are positioned opposite from one another and are generally parallel to one another, with the first side edge 322 being generally co-planar with the first side edge 314 of the first portion 304 and with the third side edge 326 being generally co-planar with the third side edge 318 of the first portion 304. The second side edge 324 connects a first side of the first side edge 322 to a first side of the third side edge 326. The second side edge 324 is generally outwardly curved such that the first, second and third side edges 322, 324, 326 generally are formed in a U-shaped configuration. The fourth side edge (not shown) connects a second side of the first side edge 322 to a second side of the third side edge 326. The fourth side edge is generally perpendicular to the first and third side edges 322, 326 and positioned opposite of the second side edge 324, such that the fourth side edge of the second portion 306 is generally parallel to the fourth side edge of the first portion 304. An aperture 328 is provided generally through a center of the second portion 306 from the upper surface 310 to the lower surface 312.

The third portion 308 has a first side edge (not shown), a second side edge 330, a third side edge (not shown), and a fourth side edge 332. The first side edge is connected along the fourth side edge of the first portion 304 and the third side edge is connected along the fourth side edge of the second portion 306. The second side edge 330 connects the first side edge 314 of the first portion 304 to the first side edge 322 of the second portion 304. The fourth side edge 332 connects the third side edge 318 of the first portion 304 to the third side edge 326 of the second portion 304.

As best illustrated in FIGS. 11 and 14, the second side edge 330 first curves upwardly and outwardly from the first side edge 314, then second extends straight upwardly, then third curves upwardly and outwardly, then fourth curves downwardly and outwardly, then fifth extends straight downwardly, and then sixth curves downwardly and outwardly to the first side edge 322. Likewise, the fourth side edge 332 first curves upwardly and outwardly from the third side edge 318, then second extends straight upwardly, then third curves upwardly and outwardly, then fourth curves downwardly and outwardly, then fifth extends straight downwardly, and then sixth curves downwardly and outwardly to the third side edge 326. Thus, the third portion 308, when viewed from the side as in FIG. 14, appears to be generally U-shaped such that a channel 334 is defined between the lower surface 312 of the third portion 308.

A protruding spike 336, preferably in the form of a dimple, extends downwardly from the lower surface 312 of the third portion 308 proximate to the second side edge 330. A protruding spike 338, preferably in the form of a dimple, extends downwardly from the lower surface 312 of the third portion 308 proximate to the fourth side edge 332.

A cut-out 342 is formed through the mounting bracket 302, through a portion of the first portion 304 proximate to the fourth side edge thereof and into the third portion 308 to generally equidistant between the first and third side edges thereof. The cut-out 342 in the first portion 304 is generally equidistant between the first and third side edges 314, 318. The cut-out 342 in the third portion 308 is generally equidistant between the second and fourth side edges 330, 332.

A tab member 344 protrudes from the first portion 304 between the cut-out 342 and extends toward the second portion 306 and below approximately half of the third portion 308. The upper surface 310 of the tab member 344 is generally co-planar with the upper surface 310 of the first portion 304 and the second portion 306. The lower surface 312 of the tab member 344 is generally co-planar with the lower surface 312 of the first portion 304 and the second portion 306.

In operation, and as illustrated in FIGS. 15 and 16, the cable sheath 40 is inserted into the U-shaped channel 334 between the lower surface 312 of the third portion 308 and the upper surface 310 of the tab member 344 of the mounting bracket 302. The tab member 344 applies pressure to the cable sheath 40 by pinching the cable sheath 40 within the channel 334 and, thus, helps hold the cable sheath 40 in place within the U-shaped channel 334. The protruding spikes 336, 338 also bite into the outer surface of the cable sheath 40 in order to further hold the cable sheath 40 in place within the U-shaped channel 334.

Fastening members (not shown), such as screws, can then be inserted through the apertures 320, 328 of the first and second portions 304, 306, respectively, in order to mount/secure the mounting bracket 302 to the motion furniture 22. The fastening members further apply pressure to the protruding spikes 336, 338 to further hold the cable sheath 40 in place.

The assembly 300 thus eliminates additional parts and provides for assembly of the mounting bracket 302 to the cable release system 20 without the use of tools. The securement of the cable sheath 40 to the mounting bracket 302 also assists in inhibiting the cable sheaths 40 and the cable 30 from twisting and/or kinking during use.

Directing attention to the fourth embodiment of the invention, which is illustrated in FIGS. 17-22, the assembly 400 is used for securing the sheath 40 of the cable release system 20 to the motion furniture 22. The assembly 400 includes a mounting bracket 402.

As best illustrated in FIGS. 17-20, the mounting bracket 402 is preferably formed of a one-piece construction that is generally hexagonal in configuration when viewed from above. The mounting bracket 402 has an upper surface 404 and a lower surface 406. The mounting bracket 402 has a first side edge 408 which is generally straight. A second side edge 410 of the mounting bracket 402 extends from the first side edge 408 and is generally curved. A third side edge 412 of the mounting bracket 402 extends from the second side edge 410 and is generally straight. A fourth side edge 414 of the mounting bracket 402 extends from the third side edge 412 and is generally curved. A fifth side edge 416 of the mounting bracket 402 extends from the fourth side edge 414 and is generally straight. A sixth side edge 418 of the mounting bracket 402 extends from the fifth side edge 416 and is generally curved. A seventh side edge 420 of the mounting bracket 402 extends from the sixth side edge 418 and is generally straight. The seventh side edge 420 is provided opposite and parallel to the first side edge 408. An eighth side edge 422 of the mounting bracket 402 extends from the seventh side edge 420 and is generally curved. The eighth side edge 422 is provided opposite the second side edge 410. A ninth side edge 424 of the mounting bracket 402 extends from the eighth side edge 422 and is generally straight. The ninth side edge 424 is provided opposite and parallel to the third side edge 412. A tenth side edge 426 of the mounting bracket 402 extends from the ninth side edge 424 and is generally curved. The tenth side edge 426 is provided opposite the fourth side edge 414. An eleventh side edge 428 of the mounting bracket 402 extends from the tenth side edge 426 and is generally straight. The eleventh side edge 428 is provided opposite and parallel to the fifth side edge 416. A twelfth side edge 430 of the mounting bracket 402 extends from the eleventh side edge 428 to the first side edge 408 and is generally curved. The twelfth side edge 430 is provided opposite the sixth side edge 418.

The side edges 408, 410, 412, 414, 416, 418, 420, 422, 424, 426, 428, 430 extend upwardly from the lower surface 406 of the mounting bracket 402 to a beveled edge 432 which connects the upper surface 404 to the side edges 408, 410, 412, 414, 416, 418, 420, 422, 424, 426, 428, 430.

The upper surface 404 of the mounting bracket 402 is planar, except between the first and seventh side edges 408, 420 where the upper surface 404 of the mounting bracket 402 curves upwardly and then curves back downwardly to define a raised portion 434 of the mounting bracket 402, such that the first and seventh side edges 408, 420 of the mounting bracket 402 are raised upwardly proximate to the upper surface 404 of the mounting bracket 402.

An aperture 436 extends through the mounting bracket 402 from the first side edge 408 to the seventh side edge 420. The aperture 436 has first, second, third, fourth, fifth, sixth and seventh portions 438, 440, 442, 444, 446, 448, 450. The first portion 438 is open to the first side edge 408 and extends toward the seventh side edge 420. The first portion 438 is frustoconical in configuration such that the end of the first portion 438 which is not open to the first side edge 408 is smaller in diameter than the end of the first portion 438 which is open to the first side edge 408. The second portion 440 extends from the first portion 438 toward the seventh side edge 420. The second portion 440 is frustoconical in configuration such that the diameter of the second portion 440 further tapers down. The third portion 442 extends from the second portion 440 toward the seventh side edge 420. The third portion 442 is cylindrical in configuration and the wall 452 of the third portion 442 of the aperture 436 is preferably at least partially threaded. The fourth portion 444 extends from the third portion 442 toward the seventh side edge 420. The fourth portion 444 is cylindrical in configuration, but has a diameter which is less than a diameter of the third portion 442, such that a shoulder 454 is provided between the third and fourth portions 442, 444. The fifth portion 446 extends from the fourth portion 444 toward the seventh side edge 420. The fifth portion 446 is cylindrical in configuration and the wall 456 of the fifth portion 446 of the aperture 436 is preferably at least partially threaded. The fifth portion 446 has a diameter which is greater than the diameter of the fourth portion 444, and generally equivalent to a diameter of the third portion 442, such that a shoulder 458 is provided between the fourth and fifth portions 444, 446. The sixth portion 448 extends from the fifth portion 446 toward the seventh side edge 420. The sixth portion 448 is generally frustoconical in configuration such that a diameter of the sixth portion 448 distal from the fifth portion 446 is larger than a diameter of the sixth portion 448 proximate to the fifth portion 446. The seventh portion 450 extends from the sixth portion 448 to the seventh side edge 420. The seventh portion 450 is generally frustoconical in configuration such that a diameter of the seventh portion 450 at the seventh side edge 420 is larger than a diameter of the seventh portion 450 at the connection of the sixth and seventh portions 448, 450.

An aperture 460 is provided through the mounting bracket 402 from the upper surface 404 to the lower surface 406 and is positioned between the tenth side edge 426 and the raised portion 434 of the mounting bracket 402. An aperture 462 is provided through the mounting bracket 402 from the upper surface 404 to the lower surface 406 and is positioned between the fourth side edge 414 and the raised portion 434 of the mounting bracket 402.

In operation, as best illustrated in FIGS. 21 and 22, two separate cable sheaths 40 are provided. As illustrated in FIG. 21, an outer surface 464 of each cable sheath 40 proximate to an end 466 thereof is preferably threaded.

The flexible cable 30 of the cable release system 20 is inserted through the aperture 436 of the mounting bracket 402. The flexible cable 30 is then inserted through the two cable sheaths 40 and the other components of the cable release system 20, as required, are secured to either the flexible cable 30 or the cable sheaths 40.

One of the two cable sheaths 40 is then inserted into the aperture 436 through the first side edge 408 of the mounting bracket 402 and is threaded into the third portion 442 of the aperture 436 by the threading on the outer surface 464 of the cable sheath 40 and by the threading on the wall 452 of the third portion 442. The cable sheath 40 is prevented from being threaded too far into the aperture 436 by the shoulder 454 provided between the third and fourth portions 442, 444, as the cable sheath 40 has an outer diameter which is larger than the diameter of the fourth portion 444. The frustoconical first and second portions 438, 440 of the aperture 436 are provided to assist in inserting the cable sheath 40 into the aperture 436 for threading within the third portion 442 of the aperture 436.

Likewise, the other one of the two cable sheaths 40 is then inserted into the aperture 436 through the seventh side edge 420 of the mounting bracket 402 and is threaded into the fifth portion 446 of the aperture 436 by the threading on the outer surface 464 of the cable sheath 40 and by the threading on the wall 456 of the fifth portion 446. The cable sheath 40 is prevented from being threaded too far into the aperture 436 by the shoulder 458 provided between the fourth and fifth portions 444, 446, as the cable sheath 40 has an outer diameter which is larger than the diameter of the fourth portion 444. The frustoconical sixth and seventh portions 448, 450 of the aperture 436 are provided to assist in inserting the cable sheath 40 into the aperture 436 for threading within the fifth portion 446 of the aperture 436.

The threaded engagement between the outer surfaces 464 of the cable sheaths 40 and the walls 452, 456 of the third and fifth portions 442, 446, respectively, of the aperture 436 of the mounting bracket 402 secures the cable sheaths 40 within the mounting bracket 402 such that the cable sheaths 40 are prevented from being pulled through the mounting bracket 402 when a pulling force is applied thereto. The securement of the cable sheaths 40 to the mounting bracket 402 also assists in inhibiting the cable sheaths 40 and the cable 30 from twisting and/or kinking during use.

Fastening members (not shown), such as screws, can then be inserted through the apertures 460, 462 in order to mount/secure the mounting bracket 402 to the motion furniture 22.

Directing attention to the fifth embodiment of the invention, which is illustrated in FIGS. 23-37, the assembly 500 is used for securing the sheath 40 of the cable release system 20 to the motion furniture 22. The assembly 500 includes a mounting bracket 502.

As best illustrated in FIGS. 23-26, the mounting bracket 502 is preferably formed of a one-piece construction and has a generally flat lower surface 504. The mounting bracket 502 has a front side edge 506 and a rear side edge 508. A generally U-shaped portion 510 of the mounting bracket 502 extends upwardly from the lower surface 504 from the front side edge 506 to the rear side edge 508, such that the front and rear side edges 506, 508 are also generally U-shaped.

A first side portion 512 of the mounting bracket 502 is generally triangular in configuration such that it has a first edge 514, a second edge 516 and a third edge (not shown). The first edge 514 extends generally angularly outwardly from the front side edge 506 to the second edge 516. The second edge 516 extends generally angularly outwardly from the rear side edge 508 to the first edge 514. The third edge extends along one side of the U-shaped portion 510 between the front and rear side edges 506, 508.

A second side portion 518 of the mounting bracket 502 is generally triangular in configuration such that it has a first edge 520, a second edge 522 and a third edge (not shown). The first edge 520 extends generally angularly outwardly from the front side edge 506 to the second edge 522, and is generally parallel to the second edge 516 of the first side portion 512. The second edge 522 extends generally angularly outwardly from the rear side edge 508 to the first edge 520, and is generally parallel to the first edge 514 of the first side portion 512. The third edge extends along the other side of the U-shaped portion 510 between the front and rear side edges 506, 508.

An upper surface 524 of the first side portion 512 is generally flat. An upper surface 526 of the second side portion 518 is generally flat and is preferably co-planar with the upper surface 524 of the first side portion 512. The upper surfaces 524, 526 of the first and second side portions 512, 514 are not positioned as far from the lower surface 504 of the mounting bracket 502 as is the upper surface 528 of the U-shaped portion 510.

A first reinforcement portion 530 is positioned on the first side portion 512 and extends between the connection of the first and second edges 514, 516 and the U-shaped portion 510. An upper surface 532 of the first reinforcement portion 530 is not positioned as far from the lower surface 504 of the mounting bracket 502 as is the upper surface 528 of the U-shaped portion 510. An aperture 534 extends through the first reinforcement portion 530, from the upper surface 528 thereof, and through the first side portion 512 to the lower surface 504 of the mounting bracket 502.

A second reinforcement portion 536 is positioned on the second side portion 514 and extends between the connection of the first and second edges 520, 522 and the U-shaped portion 510. An upper surface 538 of the second reinforcement portion 536 is not positioned as far from the lower surface 504 of the mounting bracket 502 as is the upper surface 528 of the U-shaped portion 510. The upper surface 538 of the second reinforcement portion 536 is generally co-planar with the upper surface 532 of the first reinforcement portion 530. An aperture 540 extends through the second reinforcement portion 536, from the upper surface 538 thereof, and through the second side portion 514 to the lower surface 504 of the mounting bracket 502.

An aperture 542 extends through the U-shaped portion 510 of the mounting bracket 402 from the front side edge 506 to the rear side edge 508. The aperture 542 has first, second, third, fourth, fifth and sixth portions 544, 546, 548, 550, 552, 554. The first portion 544 is open to the front side edge 506 and extends toward the rear side edge 508. The first portion 544 is frustoconical in configuration such that the end of the first portion 544 which is not open to the front side edge 506 is smaller in diameter than the end of the first portion 544 which is open to the front side edge 506. The second portion 546 extends from the first portion 544 toward the rear side edge 508. The second portion 546 is generally cylindrical in configuration such that the diameter of the second portion 546 is consistent with the diameter of the first portion 544 at the connection of the first and second portions 544, 546. The third portion 548 extends from the second portion 546 toward the rear side edge 508. The third portion 548 is cylindrical in configuration and the wall 556 of the third portion 548 of the aperture 542 is preferably at least partially threaded. A diameter of the third portion 548 is preferably less than a diameter of the second portion 546. The fourth portion 550 extends from the third portion 548 toward the rear side edge 508. The fourth portion 550 is cylindrical in configuration, but has a diameter which is less than a diameter of the third portion 548, such that a shoulder 558 is provided between the third and fourth portions 548, 550. The fifth portion 552 extends from the fourth portion 550 toward the rear side edge 508. The fifth portion 552 is cylindrical in configuration. The fifth portion 552 has a diameter which is greater than the diameter of the fourth portion 550, and generally equivalent to a diameter of the third portion 548, such that a shoulder 560 is provided between the fourth and fifth portions 550, 552. The sixth portion 554 extends from the fifth portion 552 to the rear side edge 508. The sixth portion 554 is generally frustoconical in configuration such that a diameter of the sixth portion 554 at the rear side edge 508 is larger than a diameter of the sixth portion 554 at the connection of the fifth and sixth portions 552, 554.

In use, the assembly 500 is secured to the sheath 40 of an alternative cable release system 20′ which is illustrated in FIGS. 27-32. The alternative cable release system 20′ is similar to the cable release system 20, such that it includes the flexible cable 30, the connector member (not shown in FIGS. 27-32) and the sheath 40. The alternative cable release system 20′, however, utilizes an actuation member 38′ which is similar to the actuation member 38, and further includes a clasp member 42′, a secondary sheath 44′, and an enlarged spherical member 45′.

The actuation member 38′ is best illustrated in FIGS. 28-32. The actuation member 38′ is in the form of a D-ring, the configuration of which is well known in the art. The actuation member 38′ thus has a generally D-shaped portion 46′ having an aperture 48′ provided therethrough such that a user's hand can be inserted through the aperture 48′ in order to grip and pull the D-shaped portion 46′. An extension portion 50′ extends from the D-shaped portion 46′ to an extension end 52′. An opening 54′ is provided in the extension portion 50′. The opening 54′ includes a first portion 54a′ and a second portion 54b′. The second portion 54b′ extends from the extension end 52′ to the second portion 54b′ such that first portion 54a′ is open to the extension end 52′. The second portion 54b′ is open to a top surface 56′ of the extension portion 50′. The second portion 54b′ is larger than the first portion 54a′ such that a shoulder 58′ is provided between the first and second portions 54a′, 54b′.

The clasp member 42′ is preferably a hollow cylindrical member which is formed of metal.

The secondary sheath 44′ is preferably a hollow cylindrical member which is formed a relatively strong plastic.

The enlarged spherical member 45′ is preferably formed of metal and is fixedly secured to the second end 34 of the flexible cable 30.

In operation, the flexible cable 30, including the enlarged spherical member 45′, is first inserted through the second portion 54b′ of the opening 54′, and then through the first portion 54a′ of the opening 54′, such that the enlarged spherical member 45′ is positioned within the second portion 54b′ of the opening 54′, and prevented from going into the first portion 54a′ of the opening 54′ by the shoulder 58′, such that the first end 32 of the flexible cable 30 is provided outside of the actuation member 38′.

Thereafter, the first end 32 of the flexible cable 30 is inserted through the hollow secondary sheath 44′, until the secondary sheath 44′ is moved into the first portion 54a′ of the opening 54′.

Thereafter, the first end 32 of the flexible cable 30 is inserted through the hollow clasp member 42′, until the clasp member 42′ is moved generally against the secondary sheath 44′. The hollow clasp member 42′ is then crimped around the flexible cable 30 such that the secondary sheath 44′ is secured between the hollow clasp member 42′ and the enlarged spherical member 45′. It should be noted that the clasp member 42′ could either be clamped into position around the flexible cable 30 to either allow a little movement of the secondary sheath 44′ between the clasp member 42′ and the enlarged spherical member 45′, or such that no movement of the secondary sheath 44′ is allowed for between the clasp member 42′ and the enlarged spherical member 45′.

Thereafter, the first end 32 of the flexible cable 30 is inserted through the aperture 542 of the mounting bracket 502 from the sixth portion 554 to the first portion 544.

Thereafter, the first end 32 of the flexible cable 30 is inserted through the cable sheath 40, having an outer surface 564 at an end 566 thereof which is threaded. The threaded outer surface 564 at the end 566 of the cable sheath 40 is then inserted into the aperture 542 of the mounting bracket 502 and is threaded into the threaded wall 556 of the third portion 548 of the aperture 542.

The threaded engagement between the outer surface 564 of the cable sheath 40 and the wall 556 of the third portion 548 of the aperture 542 of the mounting bracket 502 secures the cable sheath 40 within the mounting bracket 502 such that the cable sheath 40 is prevented from being pulled through the mounting bracket 502 when a pulling force is applied thereto. The securement of the cable sheath 40 to the mounting bracket 502 also assists in inhibiting the cable sheath 40 and the cable 30 from twisting and/or kinking during use.

Fastening members (not shown), such as screws, can then be inserted through the apertures 534, 540 in order to mount/secure the mounting bracket 502 to the motion furniture 22.

The construction of the assembly 500 in conjunction with the alternative cable release system 20′ provides a number of benefits. For example, it has been a known problem that users of motion furniture have had problems with the flexible cable fraying at the base of the actuation member, such as the D-ring. The motion of releasing the actuation member caused the actuation member to twist the flexible cable. Over time the flexible cable would twist and kink and ultimately begin to fray.

The assembly 500 in conjunction with the alternative cable release system 20′ addresses this problem. As the flexible cable 30 is secured to the actuation member 38′ by the enlarged spherical member 45′ being trapped within the second portion 54b of the opening 54′ of the extension portion 50′ of the actuation member 38′, the actuation member 38′ is able to freely rotate about the enlarged spherical member 45′ and, thus, the flexible cable 30′ secured thereto. The free rotation of the actuation member 38′ eliminates twisting of the flexible cable. The construction of the actuation member 38′ also does not require for extra parts and assembly for securing the flexible cable 30 to the actuation member 38′.

The secondary sheathing 44′ protects the fabric provided on the motion furniture from damage caused by the flexible cable 30 repeatedly being moved back and forth against it, and thus, also protects the flexible cable 30 from friction against the fabric of the motion furniture which causes fraying.

The clasp member 42′ is provided to position the secondary sheathing 44′ between the clasp member 42′ and the enlarged spherical member 45′, and further to establish travel limits of the flexible cable 30 when the actuation member 38′ is pulled.

An alternative configuration of the actuation member 38′ is provided in FIGS. 33-37 and is identified as actuation member 38″. Actuation member 38″ is in the form of a D-ring, the configuration of which is well known in the art. The actuation member 38″ thus has a generally D-shaped portion 46″ having an aperture 48″ provided therethrough such that a user's hand can be inserted through the aperture 48″ in order to grip and pull the D-shaped portion 46″. An extension portion 50″ extends from the D-shaped portion 46″ to an extension end 52″.

As best illustrated in FIGS. 33-36, the extension portion 50″ is formed by a first, lower section 60″, which is fixedly secured to the D-shaped portion 46″, and a second, upper section 62″, which is attached to the first, lower section 60″ by a living hinge 64″.

The first, lower section 60″ has a partial, half groove 66″ formed at the extension end 52″ and a gap 68″ provided therein which is open to the half groove 66″, but which is larger than the groove 66″ such that a shoulder 70″ is formed between the groove 66″ and the gap 68″. To one side of the gap 68″, an aperture 72″ is provided through the first, lower section 60″. To the opposite side of the gap 68″, an aperture 74″ is provided through the first, lower section 60″. The living hinge 64″ is provided proximate to the aperture 74″ and distal to the aperture 72″.

The second, upper section 62″ has a partial, half groove 76″ formed at the extension end 52″ and a gap 78″ provided therein which is open to the half groove 76″, but which is larger than the groove 78″ such that a shoulder 80″ is formed between the groove 76″ and the gap 78″. To one side of the gap 78″, an locking tab member 82″ is provided which extends from the second, upper section 62″. To the opposite side of the gap 78″, an aperture 84″ is provided through the second, upper section 62″. The living hinge 64″ is provided proximate to the aperture 84″ and distal to the locking tab member 82″.

In operation, the enlarged spherical member 45′ is positioned within the gap 68″ such that the flexible cable 30 extends through the groove 66″ of the first, lower section 60″. The second, upper section 62″ is then folded over the first, lower section 60″ about the living hinge 64″. By folding the second, upper section 62″ over the first, lower section 60″, the following occurs: (1) the aperture 84″ is aligned with the aperture 74″ to form an aperture 86″ of the extension member 50″, as illustrated in FIG. 37; (2), the gap 68″ is aligned with the gap 78″ to form an enlarged gap (not shown) which encapsulates the enlarged spherical member 45′ therein; (3) the groove 66″ and the groove 76″ form a full, cylindrical groove (not shown) which encapsulates the flexible cable 30, and further prevents the enlarged spherical member 45′ from being pulled out of the extension member 50″ due to the formation of the shoulders 70″, 80″; and (4) the locking tab member 82″ is inserted into the aperture 72″ and is locked thereto to secure the first, lower section 60″ to the second, upper section 62″, in order to form the extension member 50″. If desired, a fastening member (not shown) can be inserted through the aperture 86″ and secured by known means in order to further secure the first, lower section 60″ to the second, upper section 62″.

Thereafter, the formation of the alternative cable release assembly 20′ is identical to that previously described. The use of the alternative actuation member 38″ provides the same benefits as does the actuation member 38′, but has a different structure.

It should be noted that the configurations of the mounting brackets 102, 202, 302, 402, 502 and the actuation members 38, 38′, 38″ described are the preferred configurations, but that other alternative configurations of the mounting brackets 102, 202, 302, 402, 502 and the actuation members 38, 38′, 38″ are considered to be within the scope of the invention as described, illustrated and claimed herein.

The configuration of the mounting brackets 102, 202, 302, 402, 502 substantially prevents the cable sheath(s) 40 from moving within the openings/channels/apertures of the mounting brackets 102, 202, 302, 402, 502.

While preferred embodiments of the present invention are shown and described, it is envisioned that those skilled in the art may devise various modifications of the present invention without departing from the spirit and scope of the appended claims.

1. An assembly for securing a cable release system to a product, the cable release system having a cable sheath and a cable extending through the cable sheath, said assembly comprising:
a mounting bracket configured to be secured to the product, said mounting bracket defining an opening for receiving the cable sheath; and
means for securing the cable sheath within said opening, said securing means configured to effectively prevent substantial movement of the cable sheath within said opening of said mounting bracket.

2. An assembly as defined in claim 1, wherein said opening is an aperture which extends through said mounting bracket.

3. An assembly as defined in claim 2, wherein said securing means is a member configured to be positioned at least partially around the cable sheath within said aperture.

4. An assembly as defined in claim 3, wherein said mounting bracket defines a cavity which is in communication with said aperture, said cavity being wider than said aperture such that first and second shoulders are defined between said cavity and said aperture, said member being bounded by said shoulders such that any movement of the cable sheath within said aperture is bounded by movement of said member.

5. An assembly as defined in claim 3, wherein said member is a retaining ring.

6. An assembly as defined in claim 2, wherein said aperture defines an aperture wall and first and second sections, said first section being larger than said second section such that a shoulder is defined between said first and second sections, said first section being sized to generally surround an end of the cable sheath, said second section being sized to generally surround the cable, said shoulder preventing the cable sheath from being positioned within said second section.

7. An assembly as defined in claim 6, wherein said securing means includes a spike member which protrudes from said aperture wall of said first section of said aperture.

8. An assembly as defined in claim 6, wherein an outer surface of the cable sheath is threaded, and wherein said securing means includes said aperture wall of said first section being threaded such that the cable sheath can be threaded into said first section of said aperture wall in order to secure the cable sheath to said mounting bracket.

9. An assembly as defined in claim 8, the cable release system further having a second cable sheath through which the cable extends and wherein said aperture further defines a third section, said third section being larger than said second section such that a shoulder is defined between said second and third sections, said third section being sized to generally surround a portion of the second cable sheath, said shoulder between said second and third sections preventing the second cable sheath from being positioned within said second section.

10. An assembly as defined in claim 9, wherein an outer surface of the second cable sheath is threaded, and wherein said securing means includes said aperture wall of said third section being threaded such that the second cable sheath can be threaded into said third section of said aperture wall in order to secure the second cable sheath to said mounting bracket.

11. An assembly as defined in claim 6, wherein said mounting bracket is generally formed from first and second portions secured to one another by a living hinge, said second portion configured to be folded over said first portion about said living hinge in order to form said aperture.

12. An assembly as defined in claim 1, wherein said mounting bracket has a tab member extending therefrom, and wherein said opening is a channel which extends between said mounting bracket and said tab member.

13. An assembly as defined in claim 12, wherein said securing means includes a spike member which protrudes from said mounting bracket.

14. A product comprising:
a cable release system having at least one cable sheath and a cable extending through said at least one cable sheath; and
an assembly for securing said at least one cable sheath to said product, said assembly including,
a mounting bracket configured to be secured to said product, said mounting bracket defining an opening for receiving said at least one cable sheath, and
means for securing said at least one cable sheath within said opening, said securing means effectively preventing substantial movement of said cable sheath within said opening of said mounting bracket.

15. A product as defined in claim 14, wherein said opening is an aperture which extends through said mounting bracket.

16. A product as defined in claim 15, wherein said securing means is a member configured to be positioned at least partially around said at least one cable sheath within said aperture.

17. A product as defined in claim 16, wherein said mounting bracket defines a cavity which is in communication with said aperture, said cavity being wider than said aperture such that first and second shoulders are defined between said cavity and said aperture, said member being bounded by said shoulders such that any movement of said at least one cable sheath within said aperture is bounded by movement of said member.

18. A product as defined in claim 16, wherein said member is a retaining ring.

19. A product as defined in claim 15, wherein said aperture defines an aperture wall and first and second sections, said first section being larger than said second section such that a shoulder is defined between said first and second sections, said first section being sized to generally surround an end of said at least one cable sheath, said second section being sized to generally surround the cable, said shoulder preventing said at least one cable sheath from being positioned within said second section.

20. A product as defined in claim 19, wherein said securing means includes a spike member which protrudes from said aperture wall of said first section of said aperture.

21. A product as defined in claim 19, wherein an outer surface of said at least one cable sheath is threaded, and wherein said securing means includes said aperture wall of said first section being threaded such that said at least one cable sheath can be threaded into said first section of said aperture wall in order to secure said at least one cable sheath to said mounting bracket.

22. A product as defined in claim 21, said cable release system having a second cable sheath through which the cable extends and wherein said aperture further defines a third section, said third section being larger than said second section such that a shoulder is defined between said second and third sections, said third section being sized to generally surround a portion of said second cable sheath, said shoulder between said second and third sections preventing said second cable sheath from being positioned within said second section.

23. A product as defined in claim 22, wherein an outer surface of said second cable sheath is threaded, and wherein said securing means includes said aperture wall of said third section being threaded such that said second cable sheath can be threaded into said third section of said aperture wall in order to secure said second cable sheath to said mounting bracket.

24. A product as defined in claim 21, wherein said cable release system further includes an actuation member and an enlarged member secured to an end of said cable, said actuation member defining an opening therein having first and second portions defining a shoulder therebetween, said enlarged member being secured within said second portion of said opening such that said actuation member can freely rotate about said enlarged member, said cable extending through said first portion of said opening and out of said actuation member.

25. A product as defined in claim 24, wherein said cable release system further includes a clasp member and a secondary sheath, said clasp member configured to be tightly secured around said cable, said secondary sheath configured to surround said cable and be positioned between said clasp member and said enlarged member such that said secondary sheath is configured to be positioned at least partially within said first portion of said opening.

26. A product as defined in claim 25, wherein said aperture further defines a third section, said third section being larger than said second section such that a shoulder is defined between said third and second sections, said third section being sized to generally surround said clasp member and said secondary sheath, said shoulder between said second and third sections preventing said clasp member from being positioned within said second section.

27. A product as defined in claim 24, wherein said actuation member is generally partly formed from first and second portions secured to one another by a living hinge, said second portion configured to be folded over said first portion about said living hinge in order to form said opening and to secure said enlarged member within said second portion of said opening.

28. A product as defined in claim 24, wherein said actuation member is a D-ring.

29. A product as defined in claim 19, wherein said mounting bracket is generally formed from first and second portions secured to one another by a living hinge, said second portion configured to be folded over said first portion about said living hinge in order to form said aperture.

30. A product as defined in claim 14, wherein said mounting bracket has a tab member extending therefrom, and wherein said opening is a channel which extends between said mounting bracket and said tab member.

31. A product as defined in claim 30, wherein said securing means includes a spike member which protrudes from said mounting bracket.

32. A cable release system configured to be secured to a mounting bracket secured to a product, the mounting bracket having an aperture which extends therethrough and which defines an aperture wall which is at least partially threaded, said cable release system comprising:
a cable, said cable being configured to be at least partially positioned within the aperture of the mounting bracket;
a sheath configured to generally encapsulate a portion of said cable, said cable capable of moving through said sheath, said sheath having an outer surface which is partially threaded, said threaded outer surface of said sheath configured to be threadedly engaged with the threaded aperture wall of the mounting bracket in order to secure said sheath to the mounting bracket;
an enlarged member fixedly secured to an end of said cable; and
an actuation member having an opening therein, said opening having first and second portions defining a shoulder therebetween, said enlarged member being positioned within said second portion of said opening such that said actuation member can freely rotate about said enlarged member, said cable extending through said first portion of said opening.

33. A cable release system as defined in claim 32, further comprising a clasp member and a secondary sheath, said clasp member configured to be tightly secured around said cable, said secondary sheath configured to surround said cable and be positioned between said clasp member and said enlarged member such that said secondary sheath is configured to be positioned at least partially within said first portion of said opening.

34. A cable release system as defined in claim 33, wherein said clasp member and said secondary sheath are configured to move within the aperture of the mounting bracket.

35. A cable release system as defined in claim 32, wherein said actuation member is generally partly formed from first and second portions secured to one another by a living hinge, said second portion configured to be folded over said first portion about said living hinge in order to form said opening and to secure said enlarged member within said second portion of said opening.

36. A cable release system as defined in claim 32, wherein said actuation member is a D-ring.
